(19) United States
(12) Patent Application Publication
(10) Pub. No.: US 2025/0388240 A1
(43) Pub. Date: Dec. 25, 2025

(54) VEHICLE CONTROL DEVICE AND VEHICLE CONTROL METHOD

(71) Applicant: DENSO CORPORATION, Kariya-city (JP)

(72) Inventors: Takuya KUME, Kariya-city (JP); Kazuki Izumi, Kariya-city (JP)

(21) Appl. No.: 19/312,290

(22) Filed: Aug. 27, 2025

Related U.S. Application Data
(63) Continuation of application No. PCT/JP2024/004321, filed on Feb. 8, 2024.

(30) Foreign Application Priority Data
Mar. 2, 2023 (JP) 2023-032174
Feb. 2, 2024 (JP) 2024-014972

(51) Int. Cl. B60W 60/00; B60W 40/08; B60W 50/00; B60W 50/14

(52) U.S. Cl. CPC B60W 60/0051; B60W 40/08; B60W 50/0097; B60W 50/14; B60W 60/0053; B60W 60/0059; B60W 2040/0827; B60W 2050/007; B60W 2050/0083; B60W 2050/143; B60W 2050/146; B60W 2540/229

(57) ABSTRACT

A vehicle control device identifies an operation received from a driver of a vehicle, and permits a traveling start by automated driving without a condition that a specific operation has been identified at a time of switching from manual driving to the automated driving, and permits the traveling start by the automated driving based on the specific operation at a traveling start time of the vehicle.

### CROSS REFERENCE TO RELATED APPLICATIONS

The present application is a continuation application of International Patent Application No. PCT/JP2024/004321 filed on Feb. 8, 2024, which designated the U.S. and claims the benefit of priority from Japanese Patent Application No. 2023-032174 filed on Mar. 2, 2023 and the benefit of priority from Japanese Patent Application No. 2024-014972 filed on Feb. 2, 2024. The entire disclosures of all of the above applications are incorporated herein by reference.

### TECHNICAL FIELD

The present disclosure relates to a vehicle control device and vehicle control method.

### BACKGROUND

For example, a technology for switching between manual driving and automated driving in a vehicle equipped with an automated driving function has been known as a comparative example. The technology of the comparative example starts operation of an automated driving function by detecting an operation by a driver to switch to the automated driving in an area where the automated driving is possible.

### SUMMARY

According to an aspect of the present disclosure, a vehicle control device is configured to start automated driving from a traveling start time and be used in a vehicle configured to switch from manual driving to the automated driving, and includes at least one of (i) a circuit and (ii) a processor with a memory storing computer program code executable by the processor, the at least one of the circuit and the processor configured to cause the vehicle control device to: identify an operation received from a driver of the vehicle; permit a traveling start by the automated driving without a condition that a specific operation has been identified at a time of switching from the manual driving to the automated driving; and permit the traveling start based on the specific operation identified at the traveling start time of the vehicle.

### BRIEF DESCRIPTION OF THE DRAWINGS

FIG. 1 is a diagram showing an example of a schematic configuration of a vehicle system according to a first embodiment.

FIG. 2 is a diagram showing an example of a schematic configuration of an automated driving ECU according to the first embodiment.

FIG. 3 is a flowchart showing an example of a flow of a traveling start-related process by the automated driving ECU according to the first embodiment.

FIG. 4 is a diagram showing an example of a schematic configuration of a vehicle system according to a second embodiment.

FIG. 5 is a diagram showing an example of a schematic configuration of the automated driving ECU according to the second embodiment.

FIG. 6 is a diagram showing an example of a schematic configuration of a vehicle system according to a third embodiment.

FIG. 7 is a diagram showing an example of a schematic configuration of the automated driving ECU according to the third embodiment.

FIG. 8 is a flowchart showing an example of a flow of a stop limitation-related process in the automated driving ECU according to the third embodiment.

FIG. 9 is a diagram showing an example of a schematic configuration of a vehicle system according to a fourth embodiment.

FIG. 10 is a diagram showing an example of a schematic configuration of the automated driving ECU according to the fourth embodiment.

FIG. 11 is a diagram showing an example of a schematic configuration of a vehicle system according to a fifth embodiment.

FIG. 12 is a diagram showing an example of a schematic configuration of the automated driving ECU according to the fifth embodiment.

FIG. 13 is a diagram showing an example of a schematic configuration of a vehicle system according to a sixth embodiment.

FIG. 14 is a diagram showing an example of a schematic configuration of the automated driving ECU according to the sixth embodiment.

FIG. 15 is a flowchart showing an example of a flow of an inhibition release-related process in the automated driving ECU according to the sixth embodiment.

### DETAILED DESCRIPTION

In the comparative example, although in an assumed case where the vehicle transitions from manual driving to automated driving, there may also be cases where the vehicle starts traveling by automated driving from the start of traveling. Even when such a vehicle travels with the automated driving from the traveling start, there is a demand to improve convenience for occupants.

One example of the present disclosure provides a vehicle control device and a vehicle control method capable of improving convenience for an occupant when the vehicle travels by automated driving from a time the occupant get in the vehicle.

According to a first example embodiment of the present disclosure, a vehicle control device is configured to start automated driving that assists steering, acceleration, and deceleration from a traveling start time and also be used in a vehicle configured to switch from manual driving to the automated driving, and the vehicle control device includes: an operation identification unit configured to identify an operation in the vehicle received from a driver of the vehicle; and a permission unit configured to permit a traveling start by the automated driving without a condition that a specific operation has been identified by the operation identification unit at a time of switching from the manual driving to the automated driving, the specific operation being a plurality of predetermined operations, and permit the traveling start by the automated driving based on the specific operation identified by the operation identification unit at the traveling start time of the vehicle.

According to a second example embodiment of the present disclosure, a vehicle control method is used for a vehicle configured to switch from manual driving to automated driving and performed by at least one processor, and the vehicle control method includes: starting the automated driving that assists steering, acceleration, and deceleration from a traveling start time; identifying an operation in the vehicle received from a driver of the vehicle; permitting a traveling start by the automated driving without a condition that a specific operation has been identified at a time of switching from the manual driving to the automated driving, the specific operation being a plurality of predetermined operations; and permitting the traveling start by the automated driving based on the identified specific operation at the traveling start time of the vehicle.

According to the above configuration, the traveling start by automated driving requires operations on the vehicle itself that are not required when switching from manual driving to automated driving. Therefore, compared to a case where this operation is not required, the occupant can start traveling in a state where the occupant is mentally prepared for starting traveling. In addition, by setting the operations required for the starting to a predetermined number of operations, it is possible to prevent the vehicle from being permitted to start traveling by the automated driving mode due to erroneous operations. As a result, when the vehicle starts traveling by the automated driving from the time when the occupant get in the vehicle, it becomes possible to improve convenience for the occupant.

According to a third example embodiment of the present disclosure, a vehicle control device is configured to start automated driving that assists steering, acceleration, and deceleration from a traveling start time and also be used in a vehicle configured to perform reclining control of an electric seat, and the vehicle control device includes: a progress amount identification unit configured to determine a progress amount from a traveling start by the automated driving of the vehicle; and an inhibition unit configured to inhibit a target motion until the progress amount identification unit determines that the progress amount has reached a specified value after the traveling start by the automated driving of the vehicle. The target motion is at least one of the reclining control or a second task that is a motion other than driving that is permitted to a driver of the vehicle.

According to a fourth example embodiment of the present disclosure, a vehicle control method is used for a vehicle configured to perform reclining control of an electric seat and performed by at least one processor, and the vehicle control method includes: starting the automated driving that assists steering, acceleration, and deceleration from a traveling start time; determining a progress amount from a traveling start by the automated driving of the vehicle; and inhibiting a target motion until the vehicle control method determines that the progress amount has reached a specified value after the traveling start by the automated driving of the vehicle. The target motion is at least one of the reclining control or a second task that is a motion other than driving that is permitted to a driver of the vehicle.

According to the above configuration, it is possible to make it difficult for the driver to pay attention to anything other than driving immediately after starting the traveling with the automated driving. Accordingly, it becomes easier for the driver to pay attention to the outside of the vehicle in a disturbing situation immediately after starting the traveling by automated driving. Accordingly, it becomes easier for the driver to respond to unforeseen circumstances during the automated driving. As a result, when the vehicle starts traveling with the automated driving from the time the occupants get in the vehicle, it becomes possible to improve convenience for the occupant.

Multiple embodiments will be described with reference to the drawings. For convenience of description, among multiple embodiments, a configuration having the same function as a configuration shown in the drawing and described in the previous embodiment may be indicated by the same reference symbol, and the description thereof may be omitted. The description of other embodiments may be referred to with respect to these portions given the same reference symbols.

### First Embodiment

### (Schematic Configuration of Vehicle System)

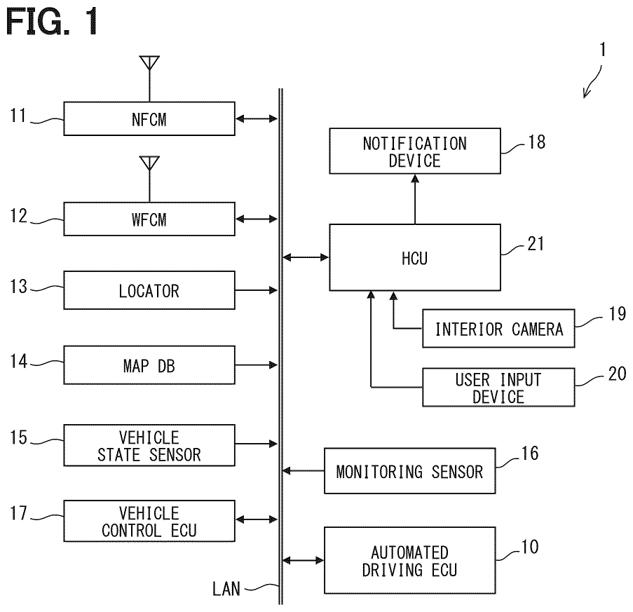

Hereinafter, a first embodiment according to the present disclosure will be described with reference to the drawings. A vehicle system 1 shown in FIG. 1 can be used for a vehicle configured to perform automated driving (hereinafter referred to as an automated driving vehicle). As shown in FIG. 1, the vehicle system 1 includes an automated driving ECU 10, a near field communication module (hereinafter, NFCM) 11, a wide-field communication module (hereinafter, WFCM) 12, a locator 13, a map database (hereinafter, map DB) 14, a vehicle state sensor 15, a periphery monitoring sensor 16, a vehicle control ECU 17, a notification device 18, an interior camera 19, a user input device 20, and a human machine interface control unit (hereinafter, HCU) 21. For example, the automated driving ECU 10, NFCM 11, WFCM 12, locator 13, map DB 14, vehicle state sensor 15, periphery monitoring sensor 16, vehicle control ECU 17, and HCU 21 may be configured to be connected to a vehicle interior LAN (see LAN in FIG. 1). Although the vehicle using the vehicle system 1 is not necessarily limited to an automobile, hereinafter, an example using the automobile will be described.

The stages of the automated driving (hereinafter, referred to as an automation level) of the automated driving vehicle include multiple levels as defined by, for example, SAE (Society of Automotive Engineers). This automation level is classified into, for example, five levels including LV0 to LV5 as follows.

The LV0 is a level where a driver performs all driving tasks without intervention of the system. The driving tasks may be reworded as dynamic driving tasks. The driving tasks are, for example, steering, acceleration and deceleration, and periphery monitoring. The LV0 corresponds to so-called manual driving. The LV1 is a level at which the system supports either the steering or the acceleration and deceleration. The LV1 corresponds to so-called driving assistance. The LV2 is a level at which the system supports both the steering and the acceleration and deceleration. The LV2 corresponds to so-called partial driving automation. The LV1 and LV2 are also part of automated driving.

For example, the automated driving at LV1 and LV2 is automated driving in which a driver has an obligation of monitoring related to safe driving. Hereinafter, the obligation is simply referred to as a monitoring obligation. That is, this corresponds to automated driving with the monitoring obligation. Incidentally, operations at LV0 to LV2 correspond to driving operations requiring monitoring obligation. As part of the monitoring obligation, there is visual monitoring of the periphery. The automated driving at LV1 and 2 can be referred to as automated driving in which a second task is not permitted. The second task is an action other than driving permitted for the driver, and is a specific action defined in advance. The second task can also be referred to as a secondary activity, other activities, or the like. The second task must not prevent the driver from responding to a request to take over a driving operation from an automated driving system. As an example, viewing of a content such as a video, operation of a smartphone, reading, and eating are assumed as the second task.

The LV3 of the automated driving is a level where the system performs all driving tasks under certain conditions, and the driver performs the driving operation in an emergency situation. In the automated driving at the LV3, it is required that the driver can quickly respond to a request of driving takeover from the system. The driving takeover can also be referred to as transfer of the periphery monitoring obligation from the vehicle system to the driver. The LV3 corresponds to so-called conditional driving automation. The automated driving at the LV4 is at a level at which the system can perform all the driving tasks except for a specific situation such as a road or a limit environment which cannot be handled. The LV4 corresponds to so-called advanced driving automation. The LV5 of the automated driving is a level at which the system can perform all the driving tasks under all environments. The LV5 corresponds to a full driving automation. The automated driving of LV4 and LV5 may be implemented, for example, in a traveling section where high-precision map data is prepared. The high-precision map data will be described later.

For example, the automated driving at LV3 or higher is an automated driving in which the driver does not have the monitoring obligation. In other words, the automated driving corresponds to automated driving without the monitoring obligation. The automated driving at LV3 or higher can be referred to as automated driving in which the second task is permitted. For example, the automated driving at level 4 or higher is automated driving in which the driver is allowed to sleep. In other words, the automated driving corresponds to sleep-permitted automated driving. The automation level LV4 corresponds to a sleep permission level. The automated driving vehicle of the present embodiment may be configured to switch the automation levels, for example. The automation levels may be configured to be switchable only between a part of the levels among LV0 to LV5. In the present embodiment, it is assumed that the automated driving vehicle is capable of performing automated driving of at least LV2 or higher from a traveling start. The “traveling start” refers to when an occupant gets in an unmanned automated driving vehicle and the vehicle starts moving.

The NFCM 11 is a communication module for performing near field wireless communication. When a communication connection is established with a portable terminal carried by an occupant in the subject vehicle, the NFCM 11 performs near field wireless communication with the portable terminal. The near field wireless communication is, for example, wireless communication whose communication range is about several tens of meters at the maximum. The near field wireless communications may be, for example, wireless communications conforming to Bluetooth (registered trademark) Low Energy. The portable terminal is, for example, a multifunctional mobile phone, a wearable device, or the like.

The WFCM 12 transmits and receives information to and from a center located outside the subject vehicle via wireless communication. That is, the WFCM 12 performs a wide field communication. The WFCM 12 receives traffic congestion information and the like from the center through the wide field communication. The WFCM 12 may transmit and receive information to and from other vehicles via the wireless communication. In other words, the WFCM 12 may perform a vehicle-to-vehicle communication. The WFCM 12 may transmit and receive information via the wireless communication with a roadside device installed on a roadside. In other words, the WFCM 12 may perform a road-to-vehicle communication. When performing the road-to-vehicle communication, the WFCM 12 may receive peripheral vehicle information transmitted from the vehicle positioned in the peripheral of the subject vehicle via the roadside device. Further, the WFCM 12 may receive information about a peripheral vehicle transmitted from the vehicle positioned in the periphery of the subject vehicle via the center by the wide field communication.

The locator 13 includes a GNSS (Global Navigation Satellite System) receiver and an inertial sensor. The GNSS receiver receives positioning signals from multiple positioning satellites. The inertial sensor includes, for example, a gyro sensor and an acceleration sensor. The locator 13 combines the positioning signals received by the GNSS receiver with a measurement result of the inertial sensor to sequentially detect the position of the subject vehicle (hereinafter, subject vehicle position). The subject vehicle position may include, for example, coordinates of latitude and longitude. The subject vehicle position may be measured by using a traveling distance acquired from signals sequentially output from a vehicle speed sensor mounted on the vehicle.

The map DB 14 is a non-volatile memory and stores the high-precision map data. The high-precision map data is map data with higher precision than the map data used for route guidance in a navigation function. The high-precision map data includes information that can be used for the automated driving operation, such as, for example, three-dimensional road shape information, information on the number of lanes, and information indicating the traveling direction allowed for each lane. In addition, the high-precision map data may also include, for example, a node point information indicating the positions of both ends of a road marking such as a lane marking. The map DB 14 may also store map data used for route guidance. The locator 13 may be configured without the GNSS receiver by using the three-dimensional shape information of the road. For example, the locator 13 may be configured to identify the subject vehicle position using three-dimensional shape information of the road and the detection results of the periphery monitoring sensor 16. The three-dimensional shape information of the road may be generated based on a captured image by REM (Road Experience Management).

Map data distributed from an external server distributed through, for example, wide field communications may be received by the WFCM 12 and stored in the map DB 14. In this case, the map DB 14 may be a volatile memory, and the WFCM 12 may sequentially acquire the map data of an area corresponding to the subject vehicle position.

The vehicle state sensor 15 is a sensor group for detecting various states of the subject vehicle. The vehicle state sensor 15 includes a vehicle speed sensor, an accelerator stroke sensor, a seat belt sensor, and the like. The vehicle speed sensor detects the speed of the subject vehicle. The accelerator stroke sensor detects depression amount of the accelerator pedal. The seat belt sensor outputs a signal according to whether the occupant has fastened a seat belt. That is, the seat belt sensor detects whether the occupant is fastening the seat belt. The vehicle state sensor 15 outputs detected sensing information to the vehicle interior LAN. Note that the sensing information detected by the vehicle state sensor 15 may be output to the vehicle interior LAN via an ECU mounted on the subject vehicle.

The periphery monitoring sensor 16 monitors a peripheral environment of the subject vehicle. For example, the periphery monitoring sensor 16 detects an obstacle in a peripheral of the subject vehicle, such as a pedestrian, a mobile object like the other vehicle, and a stationary object, and an object on the road. The periphery monitoring sensor 16 further detects a road surface marking such as a traffic lane marking around the subject vehicle. The periphery monitoring sensor 16 is, for example, a periphery monitoring camera that captures an image of a predetermined range in the periphery of the vehicle, or a search wave sensor that transmits search waves to a predetermined range in the periphery of the subject vehicle. Examples of search wave sensors include millimeter wave radar, sonar, and LIDAR (Light Detection and Ranging/Laser Imaging Detection and Ranging). For example, the predetermined range may be a range at least partially including the front, rear, left, and right areas of the subject vehicle. The periphery monitoring camera sequentially outputs, as sensing information, sequentially captured images to the automated driving ECU 10. The scanning wave sensor sequentially outputs to the automated driving ECU 10 as sensing information, the scanning result based on the received signal obtained when the reflected wave reflected by the obstacle is received.

The vehicle control ECU 17 is an electronic control unit configured to perform a traveling control of the subject vehicle. The traveling control includes an acceleration and deceleration control and/or a steering control. The vehicle control ECU 17 includes a steering ECU that performs the steering control, a power unit control ECU and a brake ECU that perform the acceleration and deceleration control, and the like. The vehicle control ECU 17 performs driving control by outputting control signals to each traveling control device mounted on the subject vehicle. Examples of the traveling control devices include an electronically controlled throttle, a brake actuator, and an EPS (Electric Power Steering) motor.

The notification device 18 is mounted in the subject vehicle and presents information to the interior of the subject vehicle. That is, the notification device 18 issues a notification to the occupants of the subject vehicle. The notification device 18 performs notification according to the instruction from the HCU 21. The notification device 18 may be, for example, a display device, a voice output device, or the like.

The display device provides notification by displaying information. The display device may be, for example, a meter MID (Multi Information Display), a CID (Center Information Display), or a HUD (Head-Up Display). The meter MID is a display device located in front of the driver seat in the compartment of the subject vehicle. As an example, the meter MID may be provided on a meter panel. The CID is a display device disposed at a center of an instrument panel of the subject vehicle. The HUD is provided in, for example, the instrument panel in the vehicle compartment. The HUD projects a display image formed by a projector onto a predetermined projection area on a front windshield as a projection member. A light of the display image reflected by the front windshield to an inside of a vehicle compartment is perceived by the driver seated in the driver's seat. As a result, the driver can visually recognize a virtual image of the display image formed in front of the front windshield which is superimposed on a part of the foreground landscape. The HUD may project the display image onto a combiner provided in front of the driver's seat instead of the front windshield. The voice output device performs notification by outputting audio. Examples of the voice output device include a speaker.

The interior camera 19 is a capturing device that captures an image of a predetermined range in the vehicle compartment of the subject vehicle. The interior camera 19 should just capture the range including the driver seat of the subject vehicle at least. The interior camera 19 may capture an image of a range including not only the driver seat of the subject vehicle but also the front passenger seat and the rear seat. The interior camera 19 includes, for example, a near-infrared light source, a near-infrared camera unit, and a control unit that controls these components. The interior camera 19 uses the near-infrared camera to capture the occupant of the subject vehicle to which the near-infrared light is emitted from the near-infrared light source.

The user input device 20 accepts input from the occupant of the subject vehicle. The user input device 20 may be an operation device that receives an operation input from the occupant. The operation device may be a mechanical switch or a touch switch integrated with the display device.

The HCU 21 mainly includes a computer including a processor, a volatile memory, a nonvolatile memory, an I/O, and a bus connecting these devices. The HCU 21 executes various processing related to an interaction between an occupant and a system of the subject vehicle by executing a control program stored in the nonvolatile memory. The HCU 21 acquires information of input received from the occupant via the user input device 20. The HCU 21 acquires information received from the occupant's portable terminal via the NFCM 11. The HCU 21 causes the notification device 18 to provide a notification. The HCU 21 acquires images captured by the interior camera 19. The HCU 21 identifies the state of the occupants of the subject vehicle from the images captured by the interior camera 19. The HCU 21 may detect the facial orientation and line of sight of the subject vehicle occupant using image recognition technology. The state of the occupant of the subject vehicle may be determined by the control unit of the interior camera 19.

The automated driving ECU 10 mainly includes a computer including a processor, a volatile memory, a nonvolatile memory, an I/O, and a bus connecting these devices, for example. The automated driving ECU 10 executes processing related to automated driving by executing a control program stored in the nonvolatile memory. The automated driving ECU 10 corresponds to a vehicle control device. The configuration of the automated driving ECU 10 will be described in detail below. (Schematic Configuration of Automated Driving ECU)

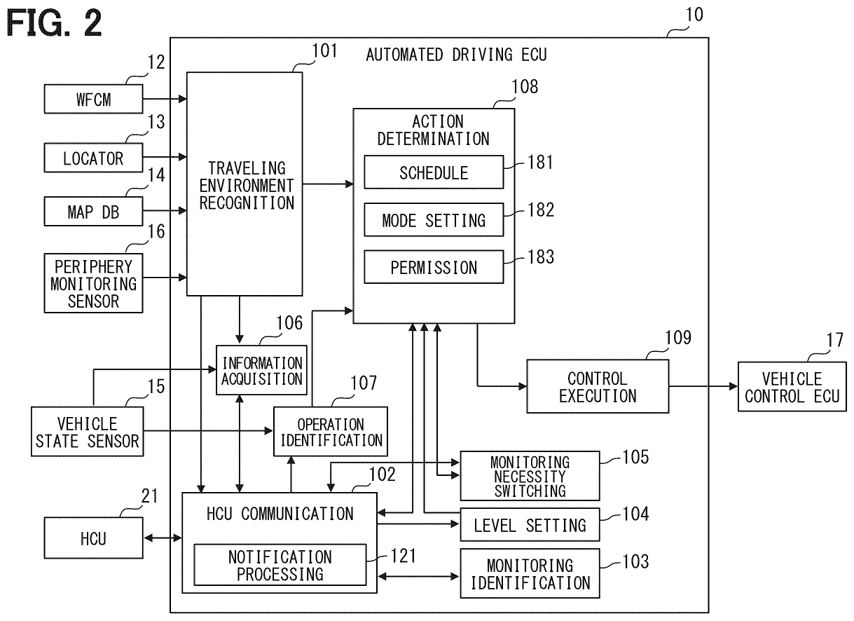

Next, a schematic configuration of the automated driving ECU 10 will be described with reference to FIG. 2. As shown in FIG. 2, the automated driving ECU 10 has functional blocks including a traveling environment recognition unit 101, an HCU communication unit 102, a monitoring identification unit 103, a level setting unit 104, a monitoring necessity switching unit 105, an information acquisition unit 106, an operation identification unit 107, an action determination unit 108, and a control execution unit 109. The execution of the processes of the functional blocks of the automated driving ECU 10 by the computer corresponds to execution of a vehicle control method. Some or all of the functions executed by the automated driving ECU 10 may be implemented as hardware with one or more ICs or the like. Some or all of the functional blocks included in the automated driving ECU 10 may be implemented by a combination of execution of software by a processor and a hardware member.

The traveling environment recognition unit 101 recognizes the traveling environment of the subject vehicle from the subject vehicle position, map data, and sensing information acquired from the periphery monitoring sensor 16. The subject vehicle position may be obtained from the locator 13. The map data may be acquired from the map DB 14. As one example, with use of these information, the traveling environment recognition unit 101 recognizes a position of an object in peripheral of the subject vehicle, a shape, and a movement state, and generates a virtual space in which the actual traveling environment is reproduced. The traveling environment recognition unit 101 may recognize a peripheral vehicle that is a vehicle in the periphery of the subject vehicle from the sensing information. More specifically, the traveling environment recognition unit 101 may recognize presence of the peripheral vehicle, a relative position of the peripheral vehicle relative to the subject vehicle, a relative speed of the peripheral vehicle relative to the subject vehicle, and the like as the traveling environment. Further, the traveling environment recognition unit 101 may recognize the position of the subject vehicle on the map from the subject vehicle position and the map data. In a case where position information, speed information, and the like of the peripheral vehicle can be acquired via the WFCM 12, the traveling environment recognition unit 101 may recognize the traveling environment using these pieces of information.

The HCU communication unit 102 executes an output processing of the information to the HCU 21 and an acquisition processing of the information from the HCU 21. The HCU communication unit 102 acquires information on the input received by the user input device 20. The HCU communication unit 102 acquires the information received by the NFCM 11. The HCU communication unit 102 acquires information such as images captured by the interior camera 19. The HCU communication unit 102 includes a notification processing unit 121 as a sub-functional block. The notification processing unit 121 indirectly controls the notification by the notification device 18 by transmitting instructions to the HCU 21. That is, the notification processing unit 121 issues a notification to the occupant of the subject vehicle. This notification processing unit 121 corresponds to a notification control unit. Details of these notification processing unit 121 will be described later.

The monitoring identification unit 103 determines whether the driver of the subject vehicle is monitoring the periphery. The monitoring identification unit 103 may determine whether the driver of the vehicle is monitoring the periphery based on the state of the subject vehicle occupants determined by the HCU 21. For example, the monitoring identification unit 103 may determine whether the driver is monitoring the periphery based on the driver's facial orientation, line of sight, and the like determined by the HCU 21.

The level setting unit 104 pre-sets the automation level of driving to be performed in an automated driving mode described below. The automated driving mode is a mode in which the vehicle can start traveling by the automated driving at LV2 or higher. The level setting unit 104 may set the automation level in response to an input for setting the automation level received by the user input device 20. The level setting unit 104 may obtain information of the input received by the user input device 20 via the HCU 21. By the level setting unit 104, automation levels, for example, LV2 to LV5, are set. The settings of the automation level by the level setting unit 104 may be performed, for example, at a previous ride prior to the current ride. In addition, the automation level set by the level setting unit 104 may be performed before the current ride and before starting the traveling.

The monitoring necessity switching unit 105 switches the necessity of monitoring the periphery of the driver of the subject vehicle. In other words, the monitoring necessity switching unit 105 sets whether monitoring of the periphery of the driver of the subject vehicle is necessary. When switching the state of the periphery monitoring to the necessary state, the monitoring necessity switching unit 105 preferably executes a process according to the automation level of the subject vehicle. For example, when the automation level of the subject vehicle is lower than LV3, an instruction may be given to the HCU 21 to cause the notification device 18 to issue a notification urging the driver to monitor the periphery. On the other hand, when the automation level of the subject vehicle is LV3 or higher, the determination by the monitoring identification unit 103 that periphery monitoring is being performed can be added to conditions for permitting the subject vehicle to start traveling in the automated driving mode.

The monitoring necessity switching unit 105 may switch the state of the periphery monitoring to the unnecessary state when an operation to activate the driving source for traveling of the subject vehicle is performed by operating the input device. The driving source includes an internal combustion engine or a motor generator. The operation for starting the internal combustion engine is to turn on an ignition power. The operation for starting the motor generator is to turn on a system main relay power source. The ignition power supply and the system main relay power source may be turned on, for example, by turning on a power switch. In the following description, it is assumed that the ignition power source and the system main relay power source are turned on by turning on the power switch. The power switch corresponds to an input device referred to here. On the other hand, when an operation to activate the driving source for traveling of the subject vehicle is performed by remote control, the monitoring necessity switching unit 105 may switch the periphery monitoring to a necessary state. Remote control may be performed from the portable terminal of the occupant of the subject vehicle. When the driving source is operated by the remote control, a signal instructing the operation of the driving source can be transmitted from the portable terminal. This signal may be received by the NFCM 11. When the operation for operating the driving source for the subject vehicle is performed by remote control, there is a possibility that the driver is not in the subject vehicle. In such a case, it is highly likely that the driver is not monitoring the periphery of the subject vehicle. According to the above configuration, it is possible to switch the necessity of monitoring the periphery depending on whether there is a high possibility that the driver is not monitoring the periphery of the subject vehicle.

The monitoring necessity switching unit 105 may switch the state of the periphery monitoring to the unnecessary state when the subject vehicle starts traveling forward. On the other hand, when the subject vehicle starts traveling backwards, the monitoring necessity switching unit 105 may switch the state of the periphery monitoring to the necessary state. Whether the subject vehicle starts by moving forward or backwards can be determined from a traveling schedule determined by a traveling schedule unit 181, which will be described later. For example, when the subject vehicle is parked in a state where the subject vehicle can only start traveling backwards, the traveling schedule unit 181 may determine a traveling schedule in which the subject vehicle starts traveling backward. On the other hand, when the subject vehicle is parked in a state where it can start moving forward, the traveling schedule unit 181 may determine a traveling schedule for starting traveling forward. When the vehicle starts traveling backward, the driver is less likely to unintentionally monitor the periphery in the traveling start direction than when the subject vehicle starts traveling forwards. In contrast, with the above configuration, when it is unlikely that the driver will be able to unintentionally monitor the periphery in the traveling start direction, it is possible to switch to a state where the monitoring of the driver's periphery is necessary.

The information acquisition unit 106 acquires subject vehicle-related information. The subject vehicle-related information is information about at least one of the subject vehicle, the traveling environment of the subject vehicle, or the driver of the subject vehicle. The information about the subject vehicle may be, for example, the scheduled traveling distance of the subject vehicle. The information about the driver may be the physical condition of the driver. The information acquisition unit 106 may acquire the traveling environment recognized by the traveling environment recognition unit 101 as the traveling environment of the subject vehicle. The information acquisition unit 106 may acquire the scheduled traveling distance of the subject vehicle from the traveling schedule determined by the traveling schedule unit 181, which will be described later. The information acquisition unit 106 may acquire information about the driver's physical condition from the driver's portable terminal via the NFCM 11. In this case, it is assumed that the driver's portable terminal stores information about the driver's physical condition input by the driver. Information on the driver's physical condition may be detected by a biosensor. The subject vehicle-related information may include information other than the described example.

The notification processing unit 121 may perform a notification proposing a traveling start recommendation level (hereinafter, referred to as a level proposal notification) in accordance with the subject vehicle related information acquired by the information acquisition unit 106. For example, when the driver is in poor physical condition, a notification may be made proposing a higher automation level than when the driver is in good physical condition. Also, when the driver is in a stressed state, a notification may be made proposing a lower automation level than when the driver is not in the stressed state. Thereby, the driver is possible to relieve stress by driving. In addition, as the scheduled driving distance increases, a notification proposing a higher automation level may be provided. Thereby, it is possible to reduce the driver's load as the situation becomes more likely to become heavier. Alternatively, the less suitable the traveling environment is for automated driving, the lower the automation level proposed in the notification becomes. Thereby, it is possible to prevent situations where a driving takeover to manual driving is required from frequently occurring. The traveling start recommendation level is the driving automation level that is recommended to the driver as the automation level to be performed when the subject vehicle starts traveling. The traveling start recommendation level may include automation level 0. The driver who receives the level proposal notification will input the setting of the proposed automation level into the user input device 20. The automation level inputted via the user input device 20 is then set by the level setting unit 104. According to the above configuration, it becomes possible to perform automated driving from the traveling start time at the automation level that is estimated to be preferable for the driver.

The operation identification unit 107 identifies an operation of the subject vehicle received from the driver of the subject vehicle. The operation in the subject vehicle may be an operation received by the user input device 20. An example of such an operation is an operation for setting a destination of the subject vehicle (hereinafter, referred to as a destination setting operation). Other such operations include the operation of a button to start automated driving (hereinafter, automated driving button operation). The button for starting the automated driving may be, for example, a mechanical switch provided on the steering wheel. Furthermore, the operation on the subject vehicle includes the operation of the equipment of the subject vehicle. An example of such an operation is the operation of an accelerator pedal (hereinafter, referred to as an accelerator operation). Another such operation is the operation of fastening a seat belt (hereinafter referred to as the “seat belt fastening operation”). The process by the operation identification unit 107 corresponds to an operation identification process.

The action determination unit 108 switches the control subject of driving operation control between the driver and the system of the subject vehicle. In a case where the control right of the driving operation is on the system side, the action determination unit 108 determines a traveling schedule for causing the subject vehicle to travel based on the recognition result of the traveling environment by the traveling environment recognition unit 101. The action determination unit 108 includes the traveling schedule unit 181, a mode setting unit 182, and a permission unit 183 as sub-functional blocks.

The traveling schedule unit 181 determines a traveling schedule for causing the subject vehicle to travel by the automated driving. The traveling schedule unit 181 determines a long-to medium-term traveling schedule and a short-term traveling schedule as traveling schedules. In the long-to medium-term traveling schedule, a scheduled route for causing the subject vehicle to travel toward a set destination is determined. The traveling schedule unit 181 may determine this scheduled route in a manner similar to the route search of the navigation function. The traveling schedule unit 181 may also determine the set vehicle speed when traveling along the scheduled route. The traveling schedule unit 181 uses the virtual space around the subject vehicle generated by the traveling environment recognition unit 101 to determine the short-term traveling schedule for implementing traveling in accordance with the long- to medium-term traveling schedule. Specifically, the short-term traveling schedule determines the execution of steering for lane changes, acceleration/deceleration for speed adjustment, and steering and braking for obstacle avoidance.

In addition, the traveling schedule unit 181 may also determine a schedule for switching the automation level of the subject vehicle (hereinafter referred to as a level switching schedule) as part of the traveling schedule. The traveling schedule unit 181 determines a level switching schedule for a foreseeable situation. For example, when the permitted automation level differs depending on the road type, the level switching schedule is determined depending on the road type of the traveling section along which the subject vehicle is scheduled to travel. In addition, the traveling schedule unit 181 predicts the occurrence of a situation in which the subject vehicle cannot perform automated driving (hereinafter, an automated driving impossible situation). Therefore, the traveling schedule unit 181 corresponds to a situation prediction unit. The automated driving impossible situation includes road construction and the like. The traveling schedule unit 181 determines whether the subject vehicle will reach a position where the automated driving impossible situation occurs within a predetermined distance or a predetermined time after the vehicle starts traveling. The position from which the subject vehicle starts may be the scheduled departure position. The predetermined distance or time may be a distance or time that is estimated to be bothersome when the driver change is made after starting traveling. The predetermined time here may be any value that can be set suitably. Whether the subject vehicle will reach a position where the automated driving impossible situation occurs within a predetermined time after starting traveling can be determined based on the scheduled vehicle speed. Then, when the traveling schedule unit 181 estimates that the position will be reached, it may determine a traveling schedule for manual driving from the traveling start position to the position where the automated driving impossible situation occurs. On the other hand, when the traveling schedule unit 181 estimates that the position will not be reached, it may determine the traveling schedule to switch to manual driving just before the position where the automated driving impossible situation occurs.

The mode setting unit 182 sets the mode when the subject vehicle starts traveling. The modes include a manual driving mode and an automated driving mode. The automated driving mode is a mode in which the vehicle can start traveling by the automated driving. The manual driving mode is a mode in which the vehicle starts traveling by the manual driving. In the automated driving mode, starting is possible at the automation level set by the level setting unit 104. Thereby, it is possible to start traveling with automated driving at the automation level according to the request of the driver.

The mode setting unit 182 sets the mode to the automated driving mode when an operation to activate the driving source for traveling of the subject vehicle is performed as a trigger. That is, the mode setting unit 182 sets the automated driving mode when the power switch is turned on. On the other hand, when the operation identification unit 107 identifies an operation for requesting manual driving, the mode setting unit 182 switches from the automated driving mode to the manual driving mode. An operation for requesting manual driving is an operation other than a specific operation described later. An operation for requesting manual driving is, for example, the operation of a dedicated switch for requesting manual driving. This dedicated switch may be a touch switch. According to the above configuration, even when the default setting of the subject vehicle is to start traveling by the automated driving, the subject vehicle can start traveling by the manual driving according to the driver request.

Furthermore, when the automation level is set to 0 by the level setting unit 104, the mode setting unit 182 may be configured as follows. The mode setting unit 182 may be configured to set the manual driving mode when the automation level is set to 0 and the power switch is turned on. This configuration also makes it possible to start the traveling of the subject vehicle by the manual driving according to the driver request.

The mode setting unit 182 sets the mode to manual driving mode when the traveling schedule unit 181 predicts the occurrence of the automated driving impossible situation within a specified distance or a specified time after the subject vehicle starts traveling. This setting is performed even when an operation is performed to operate the driving source for traveling of the subject vehicle. In other words, the automated driving mode is not set, but the manual driving mode is set. As described above, the predetermined distance or the predetermined time may be set to a distance or time that is estimated to be bothersome when the driving takeover occurs after starting traveling. The predetermined time here may be any value that can be set suitably. Thereby, it is possible to reduce the bother due to the driving takeover to manual driving immediately after the traveling start.

The permission unit 183 permits the traveling start of automated driving. In this case, permission may mean not prohibiting traveling with the automated driving, or may mean releasing the limitation that prohibits the traveling with the automated driving. The automated driving referred to here is automated driving that assists with both steering and acceleration/deceleration. In other words, the automated driving is at least LV2 or higher. The same applies to the following. The processes by the permission unit 183 corresponds to a permission process.

When the subject vehicle starts traveling, the permission unit 183 permits the subject vehicle to start traveling by the automated driving based on the specific operation identified by the operation identification unit 107. The specific operations are multiple predetermined operations. The specific operation may be configured not to include the operation of turning on the power switch. For example, the specific operations may be the three operations of the destination setting operation, the automated driving button operation, and the accelerator operation described above. The specific operations may be the four operations of above-described destination setting operation, automated driving button operation, accelerator operation, and seat belt operation. The specific operation is not limited to the above examples. The specific operation does not include the operation of a dedicated switch to request manual driving. The specific operation may include an operation that is essential when starting traveling by manual driving, but the specific operation is different from the combination of operations that is essential when starting traveling by manual driving. The specific operations include operations that are not essential when starting traveling by manual driving. On the other hand, when switching from manual driving to automated driving, the permission unit 183 permits the start of traveling in automated driving without the condition that the specific operation has been identified by the operation identification unit 107.

According to the above configuration, the traveling start by automated driving requires operations on the subject vehicle itself that are not required when switching from manual driving to automated driving. Therefore, compared to a case where this operation is not required, the occupant can start traveling in a state where the occupant is mentally prepared for starting traveling. In addition, by setting the operations required for starting to a predetermined number of operations, it is possible to prevent the vehicle from being permitted to start traveling by the automated driving mode due to erroneous operations. As a result, when the vehicle starts to operate in automated driving from the time the occupant gets in, it becomes possible to improve convenience for the occupant.

When the monitoring necessity switching unit 105 has performed switching to the periphery monitoring necessary state and also the automation level of the subject vehicle is LV3 or higher, the permission unit 183 may perform the following. The permission unit 183 may add the identification, by the monitoring identification unit 103, that periphery monitoring is being performed to conditions for permitting the subject vehicle to start traveling by the automated driving. In other words, in a case where the subject vehicle starts traveling, when the operation identification unit 107 identifies a specific operation and the monitoring identification unit 103 identifies that periphery monitoring is occurring, the permission unit 183 may permit the vehicle to start traveling by automated driving. According to this, in cases where it is preferable for the driver to monitor the periphery, it becomes possible to permit the vehicle to start traveling by automated driving by adding the condition that monitoring of the periphery has been performed. Thereby, it becomes easier for the driver to respond to unforeseen circumstances by automated driving. As a result, when the vehicle starts traveling with the automated driving from the time the occupants get in the vehicle, it becomes possible to more improve convenience for the occupant.

When the automation level set by the level setting unit 104 is LV4 or higher, the permission unit 183 may reduce the number of specific operations compared to when the automation level is lower than LV3. The automation level set by the level setting unit 104 is the automation level of automated driving that is permitted based on the specific operation identified by the operation identification unit 107 at the traveling start time of the subject vehicle. The automated driving at LV4 or higher has advantages because the number of operations requiring the driver is few. According to the above configuration, it is possible to improve convenience for the occupant while preventing the decline in the advantages of automated driving of LV4 or higher.

When an operation to activate the driving source for traveling of the subject vehicle is performed by remote control, the permission unit 183 may set a larger number of specific operations than when the operation is performed by operating the input device. The operation of the input device may be the occupant turning on the power switch. When the operation to activate the driving source for traveling of the subject vehicle is performed by remote control, there is a high possibility that the driver will activate the driving source without being able to monitor the periphery of the subject vehicle. In contrast, with the above configuration, by increasing the number of specific operations, it becomes less likely that a situation will occur in which the driver is unable to monitor the periphery of the subject vehicle and the subject vehicle is permitted to start traveling by automated driving.

The permission unit 183 may increase the number of specific operations when the subject vehicle starts traveling backward compared to when the subject vehicle starts traveling forward. As described above, whether the subject vehicle starts traveling forward or backward can be determined from the traveling schedule determined by the traveling schedule unit 181. When the subject vehicle starts traveling backwards, the driver is less likely to unintentionally monitor the periphery in the traveling start direction than when the subject vehicle starts traveling forwards. In contrast, with the above configuration, by increasing the number of specific operations, it is possible to prevent the occurrence of a situation in which the subject vehicle is permitted to start traveling by the automated driving in the state where the driver is unable to monitor the periphery in the traveling start direction of the subject vehicle.

The control execution unit 109 executes traveling control in cooperation with the vehicle control ECU 17 when the control right of driving operation is held by the system of the subject vehicle itself. The control execution unit 109 executes traveling control such as acceleration/deceleration control and steering control of the subject vehicle in accordance with the traveling schedule determined by the action determination unit 108. That is, the control execution unit 109 performs automated driving.

### (Traveling Start-Related Process by Automated Driving ECU)

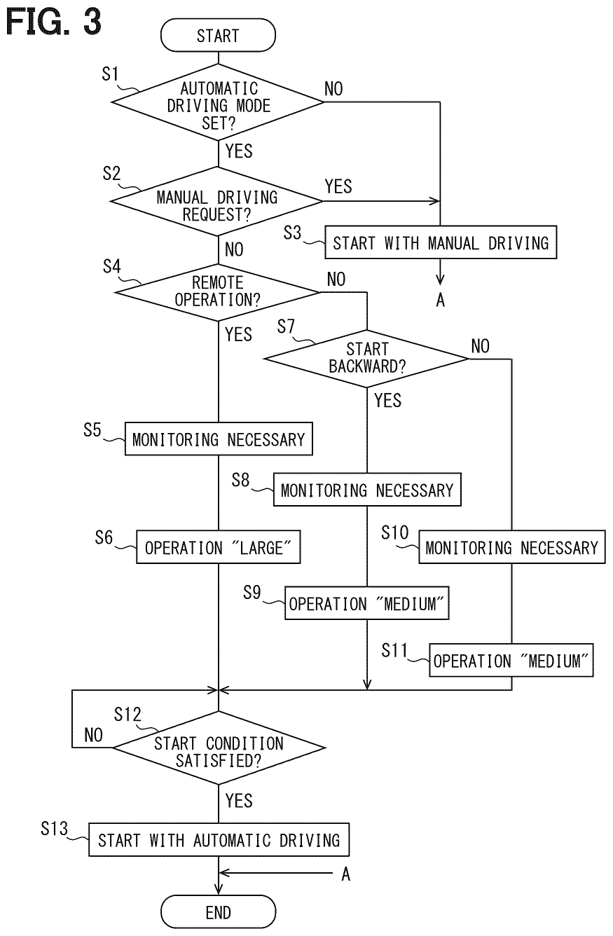

Here, an example of the flow of processes (hereinafter, traveling start-related process) related to traveling start by the automated driving ECU 10 will be described with reference to a flowchart of FIG. 3. The flowchart of FIG. 3 may be configured to start when the driving source for traveling the subject vehicle is activated. The driving source for the subject vehicle can be operated either by remote control before the occupant gets into the subject vehicle, or by turning on the power switch after the occupant gets into the subject vehicle. In the flowchart of FIG. 3, description will be given on the assumption that the number of the specific operations is classified into “large”, “medium” and “few” in decreasing order.

First, in S1, when the automated driving mode has been set by the mode setting unit 182 (YES in S1), the process proceeds to S2. On the other hand, when the manual driving operation mode has been set by the mode setting unit 182 (NO in S1), the process proceeds to S3. In S2, when the operation identification unit 107 identifies an operation for requesting manual driving (YES in S2), the process proceeds to S3. On the other hand, when the operation for requesting manual driving has not been identified by the operation identification unit 107 (NO in S2), the process proceeds to S5. As one example, when an operation for requesting manual driving cannot be identified within a certain period after the operation of the driving source for traveling of the subject vehicle, the process may proceed to S5. Without being limited to the above example, a configuration may be adopted in which the process proceeds to S3 when the operation identification unit 107 identifies an operation for requesting manual driving before the subject vehicle starts traveling.

In S3, the traveling of the subject vehicle is started by manual driving, and the traveling start-related process ends. In manual driving, for example, the subject vehicle may be started when the following conditions are satisfied. One of the conditions may be that a shift position is in a neutral position or a parking position. One of the conditions is that a parking brake is released. One of the conditions may be that an accelerator pedal is depressed.

In S4, when the operation of the driving source for traveling of the subject vehicle has been performed by remote control (YES in S4), the process proceeds to S5. On the other hand, when the operation of the driving source for traveling of the subject vehicle has been performed by turning on the power switch (NO in S4), the process proceeds to S7.

In S5, the monitoring necessity switching unit 105 sets the state of the periphery monitoring to the necessary state. In S6, the permission unit 183 determines that the number of specific operations is “large”, and the process proceeds to S12. For example, when the number of operations is “large,” the specific operations may be four operations of the destination setting operation, the automated driving button operation, the accelerator operation, and the seat belt operation.

In S7, when the subject vehicle starts traveling backward (YES in S7), the process proceeds to S8. On the other hand, when the subject vehicle starts traveling forward (NO in S7), the process proceeds to S10. In S8, the monitoring necessity switching unit 105 sets the state of the periphery monitoring to the necessary state. In S9, the permission unit 183 determines the number of the specific operations to be “medium,” and the process proceeds to S12. For example, when the number of specific operations is “medium,” the specific operations may be three operations of the destination setting operation, the automated driving button operation, and the accelerator operation.

In S10, the monitoring necessity switching unit 105 sets the state of the periphery monitoring to the unnecessary state. In S11, the permission unit 183 determines that the number of specific operations is “few,” and the process proceeds to S12. For example, when the number of specific operations is “few”, the specific operations may be two operations of the automated driving button operation and the accelerator operation.

In S12, when the permission unit 183 determines that the subject vehicle satisfies the conditions for traveling start in automated driving (YES in S12), it permits the traveling start in automated driving and the process proceeds to S13. On the other hand, when the permission unit 183 determines that the subject vehicle does not satisfy the conditions for the traveling start in automated driving (NO in S12), the process of S12 is repeated. When the monitoring necessity switching unit 105 has set the state of the periphery monitoring to the necessary state, the conditions for traveling start by the automated driving are as follows. The conditions for traveling start by automated driving are that the monitoring identification unit 103 identifies that the periphery is monitored, and that the operation identification unit 107 identifies a specific operation. On the other hand, when the monitoring necessity switching unit 105 has set the state of the periphery area monitoring to the unnecessary state, the traveling start conditions by the automated driving are as follows. The traveling start condition by the automated driving is identification of the specific operation by the operation identification unit 107.

In S13, the control execution unit 109 starts traveling of the subject vehicle by automated driving, and ends the traveling start-related process. The traveling start-related process also ends when the power switch is turned off. In the example shown in the flowchart of FIG. 3, the monitoring necessity switching unit 105 sets the state of the periphery monitoring to the necessary state in the process of S8, but the present disclosure is not necessarily limited to this. In the process of S8, the monitoring necessity switching unit 105 may be configured to set the state of the periphery monitoring to the unnecessary state.

### Second Embodiment

### (Schematic Configuration of Vehicle System)

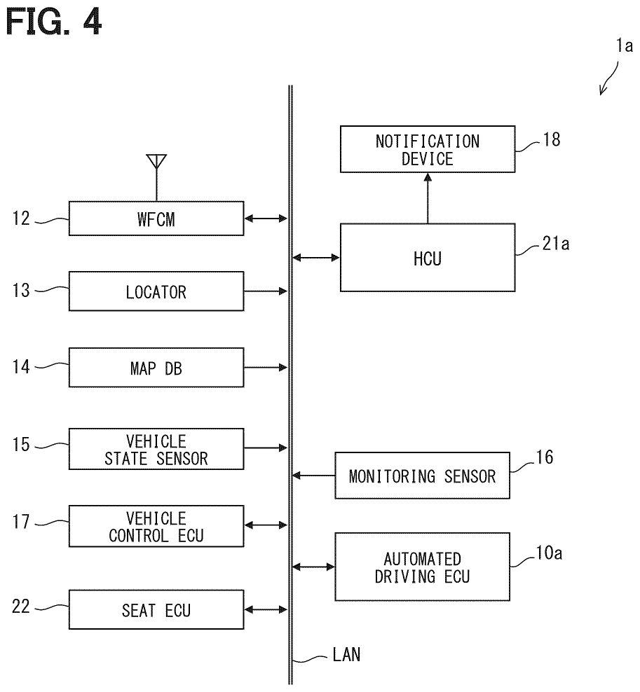

The second embodiment of the present disclosure will be described with reference to the drawings. A vehicle system 1a shown in FIG. 4 can be used in automated driving vehicle that also performs reclining control. The reclining control is a control of a reclining angle of an electric seat of the subject vehicle. For example, the reclining angle of the electric seat can be changed electrically.

As shown in FIG. 4, the vehicle system 1a includes an automated driving ECU 10a, the WFCM 12, the locator 13, the map DB 14, the vehicle state sensor 15, the periphery monitoring sensor 16, the vehicle control ECU 17, the notification device 18, an HCU 21a, and a seat ECU 22. As described above, parts having the same functions as parts shown in the drawings used in the previous description are given the same reference numerals, and the description thereof will be omitted. The HCU 21a is similar to the HCU 21 of the first embodiment, except that it performs processing according to information output from the automated driving ECU 10a.

The seat ECU 22 is an electronic control unit that executes various processes related to control of a seat environment, such as adjustment of a seat position of a seat of subject vehicle. In the following description, it is assumed that the seat of the subject vehicle is an electric seat whose slide position and reclining angle can be electrically changed. Examples of the seat include a driver seat, a passenger seat, and a rear seat. The electric seat may be provided to a part of the driver seat, the passenger seat, and the rear seat. The seat ECU 22 adjusts the seat position by controlling a motor (hereinafter referred to as a seat motor) for adjusting the seat position of the subject vehicle. Examples of the seat motor include a slide motor that adjusts the slide position and a reclining motor that adjusts the reclining angle. The slide position refers to the adjustment position of the seat in the longitudinal direction of the subject vehicle. The reclining angle indicates the adjustment angle of the inclination of the seat backrest. The seat backrest can also be referred to as a seat back. The seat ECU 22 detects the sliding position and the reclining angle. The seat ECU 22 may detect the sliding position from, for example, the rotation angle of the sliding motor. The seat ECU 22 may detect the reclining angle from the rotation angle of the reclining motor.

### (Schematic Configuration of Automated Driving ECU)

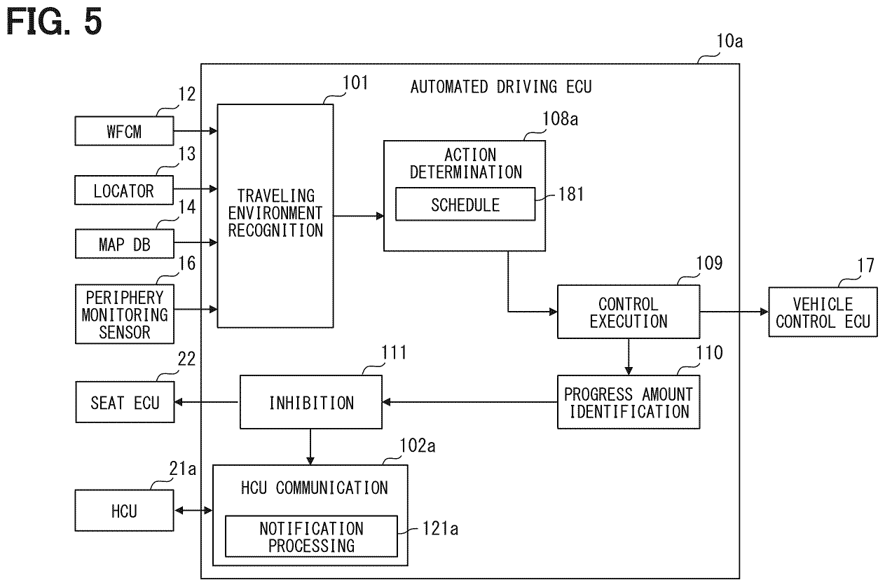

Next, a schematic configuration of the automated driving ECU 10a will be described with reference to FIG. 5. The automated driving ECU 10a has the traveling environment recognition unit 101, an HCU communication unit 102a, an action determination unit 108a, the control execution unit 109, the progress amount identification unit 110, and an inhibition unit 111 as functional blocks. This automated driving ECU 10a also corresponds to a vehicle control device. The execution of the processes of the functional blocks of the automated driving ECU 10a by the computer corresponds to execution of a vehicle control method.

The HCU communication unit 102a includes the notification processing unit 121 as a sub-functional block. The HCU communication unit 102a is similar to the HCU communication unit 102 of the first embodiment, except for some differences in processing. Details will be described later. The action determination unit 108a includes the traveling schedule unit 181 as a sub-functional block. The action determination unit 108a is similar to the action determination unit 108 of the first embodiment, except that some processes are not essential. The control execution unit 109 executes traveling control such as acceleration/deceleration control and steering control of the subject vehicle in accordance with the traveling schedule determined by the action determination unit 108a.

The progress amount identification unit 110 identifies the progress amount from the traveling start of the subject vehicle by automated driving. The progress amount identification unit 110 may determine the traveling start of the subject vehicle by automated driving based on the traveling control performed by the control execution unit 109. The progress amount may be set to an elapsed time from the traveling start of the subject vehicle by automated driving. The progress amount may be set to a traveling distance from traveling start of the subject vehicle by automated driving. The process by the progress amount identification unit 110 corresponds to a progress amount identification process.

After the subject vehicle starts traveling by automated driving, the inhibition unit 111 executes the following process until the progress amount identification unit 110 identifies that the progress amount has reached a specified value. The inhibition unit 111 inhibits a target motion which is at least one of the reclining control and the second task. The specified value may be set to an elapsed time or a traveling distance that corresponds to a period during which it is estimated that there will be many disturbances after the traveling start by the automated driving. The specified value may be set arbitrarily. The process in the inhibition unit 111 corresponds to an inhibition process.

The reclining control may be inhibited by prohibiting the reclining control. The inhibition of the reclining control may be performed by making the adjustment amount of the reclining angle smaller than in a case where the inhibition is not performed. The inhibition of the reclining control may be performed by slowing down the adjustment speed of the reclining angle compared to a case where the inhibition is not performed. The inhibition unit 111 may inhibit the reclining control by providing an instruction to the seat ECU 22. The second task can be inhibited by prohibiting the second task. The second task may be prohibited by prohibiting display and audio output, which correspond to the second task. The second task may be prohibited by causing a display indicating the prohibited second task to be displayed on a display device of the notification device 18. The second task may be inhibited by lowering the volume of the audio output from the notification device 18, which corresponds to the second task, compared to when the second task is not inhibited. The second task may be inhibited by setting the fewer number of display devices capable of displaying the second task than a case of no inhibition. The inhibition unit 111 may implement the inhibition of the second task by providing an instruction to the HCU 21.

Inhibition of the reclining control and the second task makes it difficult for the driver to pay attention to anything other than driving. Accordingly, with the above configuration, it is possible to make it difficult for the driver to pay attention to anything other than driving immediately after traveling start by automated driving. Hence, it becomes easier for the driver to pay attention to the outside of the vehicle during the period immediately after the traveling start by automated driving when there are many external disturbances. Accordingly, it becomes easier for the driver to respond to unforeseen circumstances during automated driving. As a result, when the vehicle starts traveling by the automated driving from the time when the occupant gets in the vehicle, it becomes possible to improve convenience for the occupant. The configuration of the second embodiment may be combined with the configuration of the first embodiment. For example, the configuration described in the first embodiment may be applied to permission for the subject vehicle to start traveling by automated driving.

### Third Embodiment

The present disclosure is not limited to the configuration described in the above embodiment, but can also adopt the following configuration as a third embodiment. The following will describe an example of a configuration of the third embodiment with reference to the accompanying drawings. (Schematic Configuration of Vehicle System)

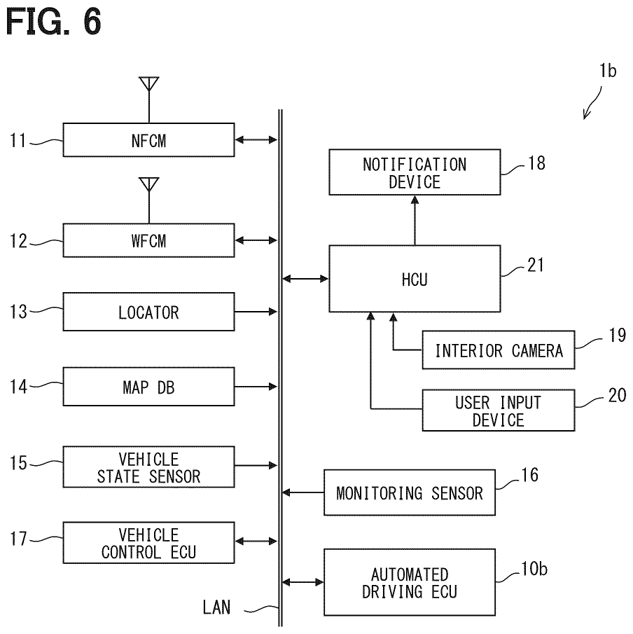

A vehicle system 1b shown in FIG. 6 can be used in the automated driving vehicle. As shown in FIG. 6, the vehicle system 1b includes an automated driving ECU 10b, the NFCM 11, the WFCM 12, the locator 13, the map DB 14, the vehicle state sensor 15, the periphery monitoring sensor 16, the vehicle control ECU 17, the notification device 18, the interior camera 19, the user input device 20, and the HCU 21. The vehicle system 1b is similar to the vehicle system 1 of the first embodiment, except that the vehicle system 1 includes the automated driving ECU 10b instead of the automated driving ECU 10.

(Schematic Configuration of Automated Driving ECU)

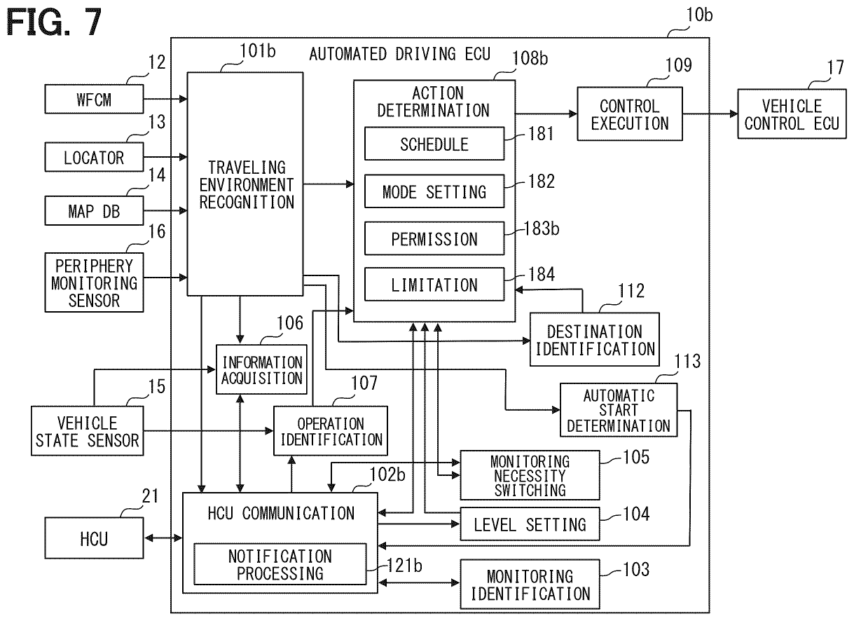

Next, a schematic configuration of the automated driving ECU 10b will be described with reference to FIG. 7. The automated driving ECU 10b is similar to the automated driving ECU 10 of the first embodiment, except for some differences in processing. The automated driving ECU 10b includes a traveling environment recognition unit 101b, an HCU communication unit 102b, the monitoring identification unit 103, the level setting unit 104, the monitoring necessity switching unit 105, the information acquisition unit 106, the operation identification unit 107, an action determination unit 108b, the control execution unit 109, a purpose identification unit 112, and an automatic traveling start determination unit 113. The automated driving ECU 10b includes the traveling environment recognition unit 101b instead of the traveling environment recognition unit 101. The automated driving ECU 10b includes the HCU communication unit 102b instead of the HCU communication unit 102. The automated driving ECU 10b includes the HCU communication unit 102b instead of the HCU communication unit 102. The automated driving ECU 10b includes the action determination unit 108b instead of the action determination unit 108. The automated driving ECU 10b includes the purpose identification unit 112 and the automatic traveling start determination unit 113. Except for these points, the automated driving ECU 10b is similar to the automated driving ECU 10 of the first embodiment. The automated driving ECU 10b also corresponds to the vehicle control device. The execution of the processes of the functional blocks of the automated driving ECU 10b by the computer corresponds to execution of the vehicle control method.

The traveling environment recognition unit 101b is similar to the traveling environment recognition unit 101 of the first embodiment, except for some differences in processing. This different point will be described below. It is preferable that the traveling environment recognition unit 101b also recognize whether the traveling environment is a safe area. The safety area here refers to an area for stopping. The safety area is an area in which the driving takeover from automated driving to manual driving is unlikely to occur. The safe area may be referred to as an area with fewer disturbances than the traveling road. The safety area is, for example, a bus stop, a parking lot, and the like. Further, the traveling environment recognition unit 101b may also recognize whether the vehicle can be stopped in a safe area. The traveling environment recognition unit 101b may determine whether the vehicle can be stopped in the safety area based on whether an obstacle of a certain size or larger is present in the safety area. A situation where it is not possible to stop the vehicle in the safe area occurs due to congestion at a bus stop, a parking lot, or the like, for example. The traveling environment recognition unit 101b corresponds to a traveling environment identification unit.

The purpose identification unit 112 identifies the purpose of starting traveling of the subject vehicle. The purpose of starting traveling of the subject vehicle is hereinafter referred to as a “traveling start purpose.” As described above, the traveling start refers to traveling start after an occupant gets into an unmanned automated driving vehicle. The purpose identification unit 112 may identify the purpose of starting traveling of the subject vehicle when, for example, the power switch of the vehicle is turned on. The traveling start purpose includes going to work and going home. The traveling start purpose may be to go to work, to go home, or to go shopping. The purpose identification unit 112 may estimate the purpose of traveling start from the destination, for example, and identify the purpose of traveling start. For example, when the destination is a company of the subject vehicle user, the traveling start purpose may be specified as going to work. The location of the user's company may be registered in advance in a non-volatile memory of the subject vehicle. When the destination is the home of the user of the subject vehicle, the traveling start purpose may be specified as “going home.” The location of the user's home may be registered in advance in the non-volatile memory of the subject vehicle. The location of the user's home may be identified based on the location that is frequently and continuously measured as the subject vehicle position. When the destination is a shopping store, the traveling start purpose can be specified as shopping. The location of the store may be identified from the map data in the map DB 14.

The automatic traveling start determination unit 113 determines whether the subject vehicle is capable of starting automated driving from the traveling start time and performing automated driving. The automated driving that starts from the traveling start time will be referred to as automatic traveling start driving hereinafter. The automatic traveling start determination unit 113 may determine whether the automatic traveling start driving is possible based on, for example, weather, route conditions, and an update status of software used for automated driving. For example, in the case of weather conditions unsuitable for automated driving, such as snow or thick fog, it may be determined that automatic traveling start driving is not possible. For example, in the case of a route situation where there is a specific position within a predetermined distance after starting traveling on the route, it may be determined that automatic traveling start driving is not possible. The specific position is a position where a switch to manual driving is necessary. For example, when an update of software used for automated driving has not been completed, it may be determined that automatic traveling start driving is not possible. The weather can be recognized by the traveling environment recognition unit 101b from images captured by the periphery monitoring cameras. The weather may be identified by the automatic traveling start determination unit 113 from weather information acquired from the center via the WFCM 12.

The action determination unit 108b is similar to the action determination unit 108 of the first embodiment, except for some differences in processing. This different point will be described below. The action determination unit 108b includes the traveling schedule unit 181, the mode setting unit 182, a permission unit 183b, and a limitation unit 184 as sub-functional blocks. The action determination unit 108b includes the permission unit 183b instead of the permission unit 183. The action determination unit 108b includes the limitation unit 184. Except for these points, the action determination unit 108b is similar to the action determination unit 108 of the first embodiment.

The limitation unit 184 changes the position where the subject vehicle is permitted to stop (hereinafter, the stoppable position). The limitation unit 184 changes the stoppable position between the manual traveling start state and the automatic traveling start state. This limitation unit 184 corresponds to a first limitation unit. The manual traveling start state is a state in which manual driving is switched to automated driving and automated driving is performed. The automatic traveling start state is a state in which automated driving is started from the traveling start time and is performed automatically. According to the above configuration, the stoppable position can be appropriately changed depending on whether the driver is involved in driving operations at traveling start. Thereby, it is possible to improve safety.

It is preferable that the limitation unit 184 changes the stoppable position so as to set limitation of stopping to the safety area in the automatic traveling start state more than in the manual traveling start state. The safe area here is an area in which a switch from automated driving to manual driving is unlikely to occur. Areas where the switch from automated driving to manual driving is unlikely to occur are areas where vehicle speed is likely to be kept low or where external disturbances are unlikely to occur. The safety area is a bus stop or a parking lot. In the case of the automatic traveling start state, since the driver has not performed any driving operations since the vehicle started, it may be difficult for the driver to respond even when a sudden driving operation is required after the vehicle has stopped. In contrast, according to the above configuration, when the vehicle is in the automatic traveling start state, stopping is limited to the safe area. It is possible to make such difficulties less likely to occur.

Furthermore, when the stoppable position so that stopping is more changed to be limited to the safety area in the automatic traveling start state more than in the manual start state, it is preferable that the limitation unit 184 performs the followings. It is preferable that the limitation unit 184 changes the stoppable position so that stopping is limited to the safety area by making it impossible to set a destination other than the safety area as the destination of the automated driving. An area other than the safety area is, for example, an area where a ban on on-street parking applies.

According to the above configuration, it becomes possible to more easily limit stopping to the safe area. The limitation unit 184 transmits an instruction to the HCU 21 via, for example, the HCU communication unit 102b. In this way, when setting a destination, the limitation unit 184 prevents the destination for automated driving from being set to an area other than the safety area. The limitation unit 184 may be configured not to impose limitations such as prohibiting parking in an area where on-street parking is prohibited.

In addition, the action determination unit 108b may change the automation level of the automated driving performed by the subject vehicle. The action determination unit 108b corresponds to a level switching unit. When changing the stoppable position so as to limit stopping to the safe area in the automatic traveling start state more than in the manual traveling start state, the action determination unit 108b preferably performs the followings. When the action determination unit 108b determines that the subject vehicle is in the automatic traveling start state and cannot stop in the safety area, it is preferable to lower the automation level of the automated driving performed by the subject vehicle. As an example, the automation level may be lowered to level 2 or below. The action determination unit 108b may determine that the subject vehicle cannot stop in the safe area based on the traveling environment recognized and identified by the traveling environment recognition unit 101b. As an example, when the safety area is blocked by an obstacle such as another vehicle, the subject vehicle may not be able to stop in the safety area. According to the above configuration, when it is not possible to stop the vehicle in a safe area, at least some of the operations are left to the driver. Thereby, it is possible to stop the vehicle more safely.

The permission unit 183b is similar to the permission unit 183 of the first embodiment, except for some differences in processing. This different point will be described below. It is preferable that the permission unit 183b reduces the amount of specific operation that is the traveling start condition when the vehicle is in the automatic traveling start state and also the traveling start purpose is to go to work or to go home, compared to when the traveling start purpose is neither to go to work nor to go home. The traveling start purpose is determined by the purpose identification unit 112. For example, when there are three specific operations that are conditions for traveling start with automated driving, the number of operations may be reduced to less than three. According to the above configuration, it is possible to reduce the number of specific operations and reduce the bother during familiar daily driving such as going to work and home. When the vehicle is in the automatic traveling start state and the traveling start purpose is neither to go to work nor to go home, the permission unit 183b may leave the operation amount of the specific operation at the default value, for example.

The HCU communication unit 102b includes a notification processing unit 121b as a sub-functional block. The HCU communication unit 102b is similar to the HCU communication unit 102 of the first embodiment, except for some differences in processing. The notification processing unit 121b also corresponds to the notification control unit. This different point will be described below. It is preferable that the notification processing unit 121b performs an automatic traveling start proposal notification when the automatic traveling start determination unit 113 determines that automatic traveling start driving is possible when the driver gets into the subject vehicle. The automatic traveling start proposal notification is a notification that suggests performing automated driving from the traveling start time. The notification processing unit 121b may determine that the driver is getting into the subject vehicle by checking whether the power switch is turned on. The notification processing unit 121b may cause the notification device 18 to issue the automatic traveling start proposal notification via the HCU 21. When the automatic traveling start determination unit 113 determines that the automatic traveling start driving is not possible, the notification processing unit 121b does not perform the automatic traveling start proposal notification. According to the above configuration, when the automatic traveling start driving is possible, the driver is possible to know that automatic traveling start driving is possible. Therefore, when automatic traveling start driving is possible, the driver is possible to start the subject vehicle without performing any additional driving operations.

It is preferable that the notification processing unit 121b performs the following notification when the automatic traveling start determination unit 113 determines that automatic traveling start driving is not possible when the driver gets into the subject vehicle. It is preferable that the notification processing unit 121b starts the automated driving from the traveling start and issues a notification indicating that the automated driving cannot be performed. According to this, when the automatic traveling start driving is not possible, the driver is possible to know that automatic traveling start driving is not possible. Therefore, it is possible to reduce the waste of the driver performing the specific operation to perform the automatic traveling start driving even though the automatic traveling start driving is not possible.

### (Stop Limitation-Related Process by Automated Driving ECU)

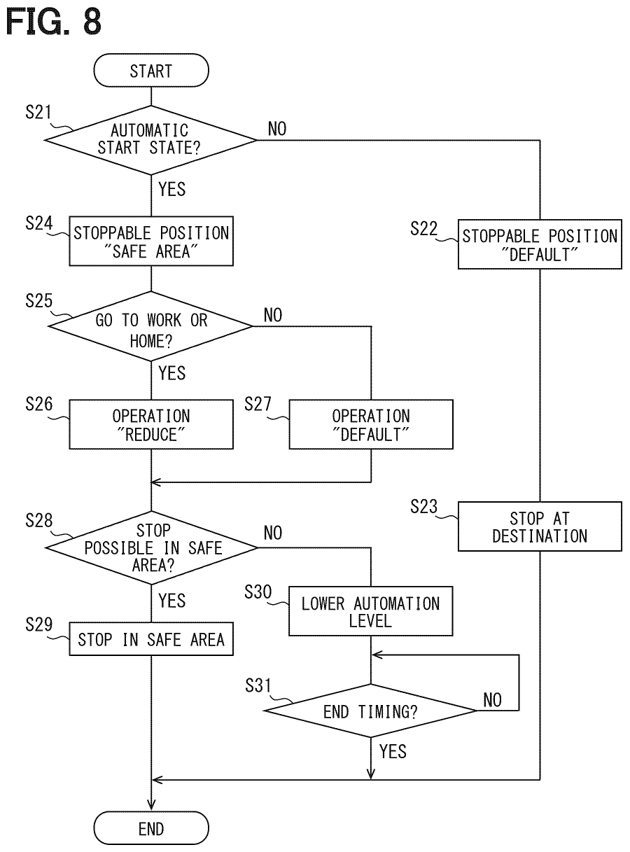

Here, an example of a flow of a process (hereinafter, stop limitation-related process) related to changes in the possible stop position by the automated driving ECU 10b will be described with reference to a flowchart of FIG. 8. The flowchart in FIG. 8 may be configured to start when the driving source for traveling of the subject vehicle is activated.

First, in S21, when the subject vehicle is in the automatic traveling start state (YES in S21), the process proceeds to S24. On the other hand, when the subject vehicle is in the manual traveling start state (NO in S21), the process proceeds to S22. In S21, when the automated driving mode has been set by the mode setting unit 182, the automatic traveling start state may be set. On the other hand, when the manual driving mode has been set by the mode setting unit 182, the manual traveling start state is set.

In S22, the limitation unit 184 keeps the stoppable position at the default. The default stoppable position may be, for example, any location other than a position where parking or stopping is prohibited by law. The default stoppable positions include areas other than the safe area. In S23, the vehicle automatically stops at the set destination, and the stop limitation-related process ends. This destination must be a position other than one where parking is prohibited by law.

In S24, the limitation unit 184 limits the stoppable position so as to limit stopping to within the safety area. In S25, when the traveling start purpose identified by the purpose identification unit 112 is to go to work or go home (YES in S25), the process proceeds to S26. On the other hand, when the traveling purpose identified by the purpose identification unit 112 is neither to go to work nor go home (NO in S25), the process proceeds to S27.

In S26, the permission unit 183b reduces the amount of the specific operation that is a condition for starting, and then the process proceeds to S28. For example, when the default specific operations are four operations of the destination setting operation, the automated driving button operation, the accelerator operation, and the seat belt operation, the number of operations may be reduced to be three or less. On the other hand, in S27, the permission unit 183b leaves the amount of the specific operation that is the traveling start condition at the default, and the process proceeds to S28. The process of S24 may be executed after S26 or S27 and before the process of S28.

In S28, when the action determination unit 108b determines that the subject vehicle can be stopped in the safe area (YES in S28), the process proceeds to S29. On the other hand, when the action determination unit 108b determines that the subject vehicle cannot be stopped in the safety area (NO in S28), the process proceeds to S30. In S29, the control execution unit 109 automatically stops the subject vehicle in the safety area, and ends the stop limitation-related process.

In S30, the action determination unit 108b lowers the automation level of the automated driving performed by the subject vehicle. This change in automation level allows the driver to stop the vehicle at a position near the safety area where there is space to stop, by the driving operation of the driver. In S31, when it is time to end the stop limitation-related process (YES in S31), the stop limitation-related process ends. The stop limitation-related process may end when the power switch of the subject vehicle is turned off and the like. On the other hand, when it is not time to end the stop limitation-related process (NO in S31), the process returns to S21 and is repeated.

### Fourth Embodiment

The present disclosure is not limited to the configuration described in the above embodiment, but can also adopt the following configuration as a fourth embodiment. The following will describe a detailed example of the fourth embodiment with reference to the accompanying drawings.

### (Schematic Configuration of Vehicle System)

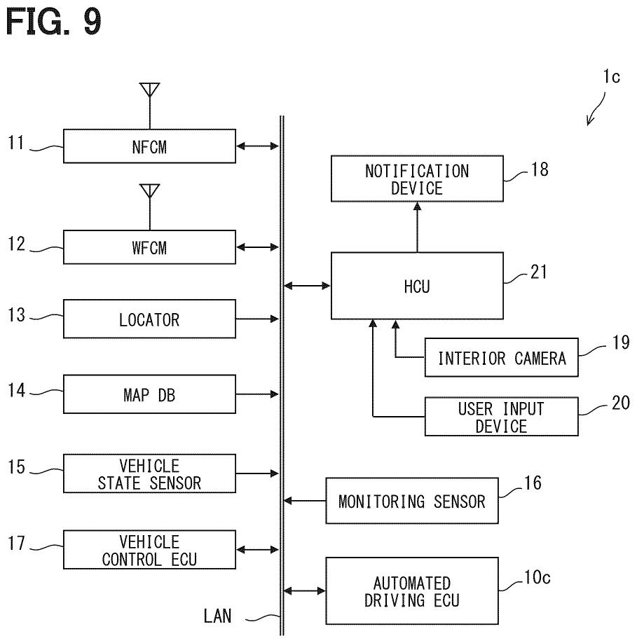

A vehicle system 1c shown in FIG. 9 can be used in an automated driving vehicle. As shown in FIG. 9, the vehicle system 1c includes an automated driving ECU 10c, the NFCM 11, the WFCM 12, the locator 13, the map DB 14, the vehicle state sensor 15, the periphery monitoring sensor 16, the vehicle control ECU 17, the notification device 18, the interior camera 19, the user input device 20, and the HCU 21. The vehicle system 1c is similar to the vehicle system 1 of the first embodiment, except that the vehicle system 1 includes the automated driving ECU 10c instead of the automated driving ECU 10.

(Schematic Configuration of Automated Driving ECU)

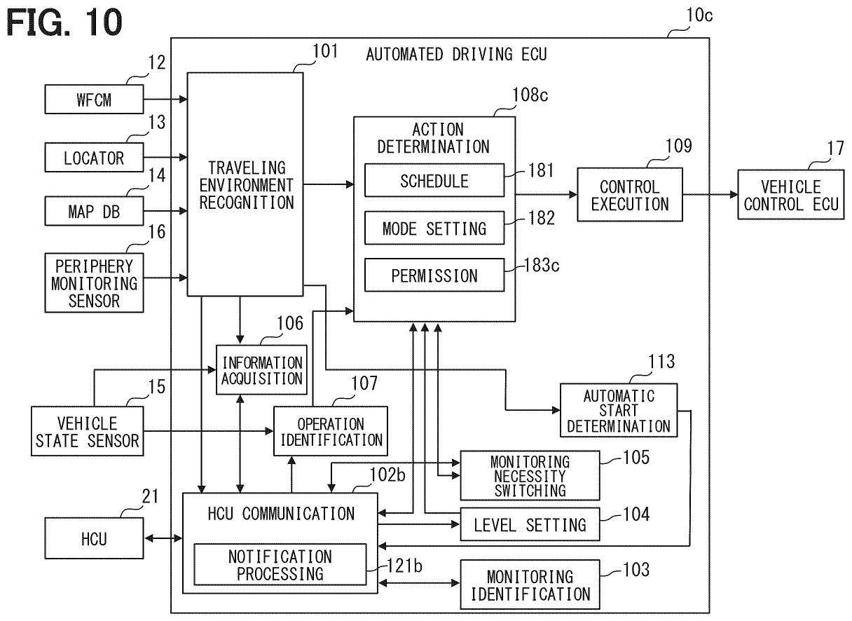

Next, a schematic configuration of the automated driving ECU 10c will be described with reference to FIG. 10. The automated driving ECU 10c is similar to the automated driving ECU 10 of the first embodiment, except for some differences in processing. The automated driving ECU 10c includes the traveling environment recognition unit 101, the HCU communication unit 102b, the monitoring identification unit 103, the level setting unit 104, the monitoring necessity switching unit 105, the information acquisition unit 106, the operation identification unit 107, an action determination unit 108c, the control execution unit 109, and the automatic traveling start determination unit 113. The automated driving ECU 10c includes the HCU communication unit 102b instead of the HCU communication unit 102. The automated driving ECU 10c includes the action determination unit 108c instead of the action determination unit 108. The automated driving ECU 10c includes the automatic traveling start determination unit 113. Except for these points, the automated driving ECU 10c is similar to the automated driving ECU 10 of the first embodiment. The automated driving ECU 10c also corresponds to the vehicle control device. The execution of the processes of the functional blocks of the automated driving ECU 10c by the computer corresponds to execution of the vehicle control method.

The HCU communication unit 102b, the purpose identification unit 112, and the automatic traveling start determination unit 113 are assumed to be similar to those described in the third embodiment. The action determination unit 108c is similar to the action determination unit 108 of the first embodiment, except for some differences in processing. This different point will be described below. The action determination unit 108c includes the traveling schedule unit 181, the mode setting unit 182, and a permission unit 183c as sub-functional blocks. The action determination unit 108c is similar to the action determination unit 108 of the first embodiment, except that the action determination unit 108c includes the permission unit 183c instead of the permission unit 183.

The permission unit 183c is similar to the permission unit 183 of the first embodiment, except for some differences in processing. This different point will be described below. In response to the automatic traveling start proposal notification, when a stop caused by an occupant operation occurs within a specified time after a specific operation is identified by the operation identification unit 107, the permission unit 183c limits the start of automated driving from the traveling start time when restarting the vehicle. The automatic traveling start proposal notification is performed, for example, in response to an instruction from the notification processing unit 121b. The specified time may be set to a short time that can be regarded as a time immediately after the specific operation is identified. The specified time may be set arbitrarily. The stop caused by the occupant operation is a stop of the subject vehicle due to an occupant operation on the subject vehicle. Examples of operations that causes the subject vehicle to stop include sudden steering of the subject vehicle and operation of an emergency stop button of the subject vehicle. The limitation on starting traveling by the automated driving here may be a limitation on speed, a limitation on acceleration, or a prohibition on starting traveling by the automated driving.

When the stop caused by the occupant operation occurs after the specific operation, it is estimated that some external factor made the stop necessary. According to the above configuration, in such a case, by limiting the traveling start of automated driving, it is possible to start traveling more safely than when no limitation was imposed. When prohibiting the traveling start of automated driving as a limitation on the traveling start of automated driving, by leaving the traveling start to the driver, it is possible to start traveling safely.

### Fifth Embodiment

The present disclosure is not limited to the configuration described in the above embodiment, but can also adopt the following configuration as a fifth embodiment. The following will describe a detailed example of the fifth embodiment with reference to the accompanying drawings.

### (Schematic Configuration of Vehicle System)

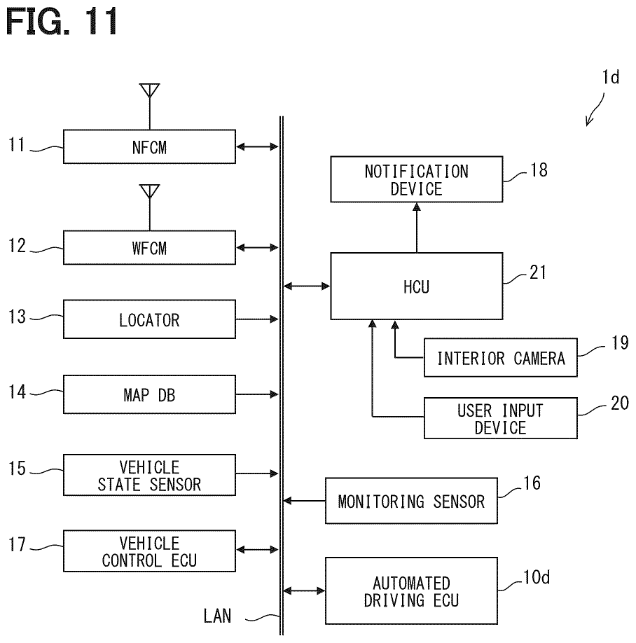

A vehicle system 1d shown in FIG. 11 can be used in the automated driving vehicle. As shown in FIG. 11, the vehicle system 1d includes an automated driving ECU 10d, the NFCM 11, the WFCM 12, the locator 13, the map DB 14, the vehicle state sensor 15, the periphery monitoring sensor 16, the vehicle control ECU 17, the notification device 18, the interior camera 19, the user input device 20, and the HCU 21. The vehicle system 1d is similar to the vehicle system 1 of the first embodiment, except that the vehicle system 1 includes the automated driving ECU 10d instead of the automated driving ECU 10.

### (Schematic Configuration of Automated Driving ECU)

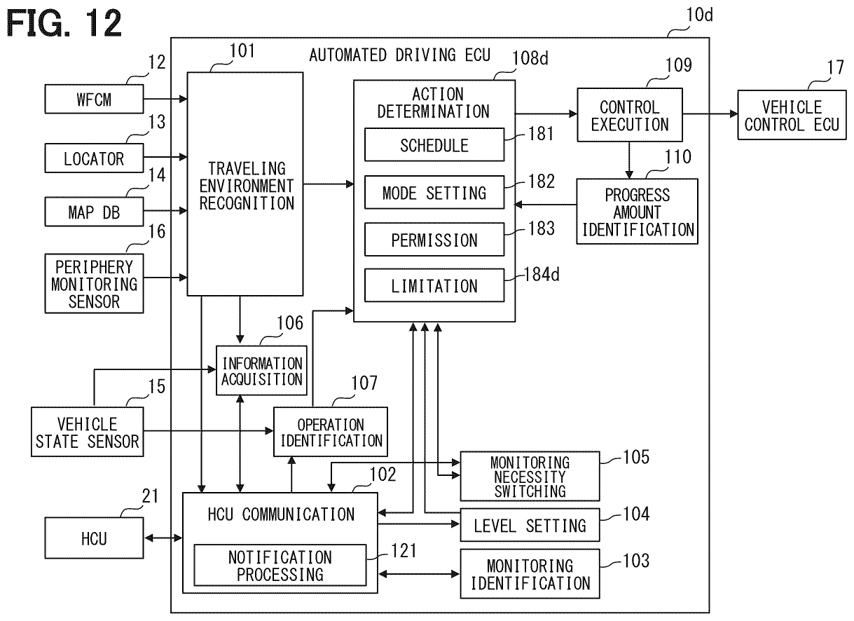

Next, a schematic configuration of the automated driving ECU 10d will be described with reference to FIG. 12. The automated driving ECU 10d is similar to the automated driving ECU 10 of the first embodiment, except for some differences in processing. The automated driving ECU 10d includes the traveling environment recognition unit 101, the HCU communication unit 102, the monitoring identification unit 103, the level setting unit 104, the monitoring necessity switching unit 105, the information acquisition unit 106, the operation identification unit 107, an action determination unit 108d, the control execution unit 109, and the progress amount identification unit 110. The automated driving ECU 10d includes the action determination unit 108d instead of the action determination unit 108. The automated driving ECU 10d includes the progress amount identification unit 110. Except for these points, the automated driving ECU 10d is similar to the automated driving ECU 10 of the first embodiment. The automated driving ECU 10d also corresponds to the vehicle control device. The execution of the processes of the functional blocks of the automated driving ECU 10d by the computer corresponds to execution of the vehicle control method.

The progress amount identification unit 110 is assumed to be the same as that described in the second embodiment. As described above, the progress amount may be the time elapsed since the subject vehicle started traveling under automated driving, or may be the distance traveled since the subject vehicle started traveling under automated driving. The action determination unit 108d is similar to the action determination unit 108 of the first embodiment, except for some differences in processing. This different point will be described below. The action determination unit 108d includes the traveling schedule unit 181, the mode setting unit 182, the permission unit 183, and a limitation unit 184d as sub-functional blocks. The action determination unit 108d is similar to the action determination unit 108 of the first embodiment, except that it includes the limitation unit 184d.

The limitation unit 184d is similar to the limitation unit 184 of the third embodiment, except for some differences in processing. This different point will be described below. After the subject vehicle starts traveling by automated driving, the limitation unit 184d more limits the acceleration of the subject vehicle until the progress amount identification unit 110 identifies that the progress amount has reached the specified value, compared to after identifying that the progress amount has reached the specified value. The limitation unit 184d corresponds to a second limitation unit. The specified value may be set to an elapsed time or a traveled distance that corresponds to a period during which it is estimated that there will be many disturbances after the traveling start of the automated driving. The specified value may be set arbitrarily. According to the above configuration, it is possible to limit the acceleration of the subject vehicle during a period during which it is estimated that there are many disturbances after the traveling start of the automated driving. Accordingly, it is less likely that the occupant of the subject vehicle feels anxiety at the traveling start by the automated driving.

### Sixth Embodiment

The present disclosure is not limited to the configuration described in the above embodiment, but can also adopt the following configuration as a sixth embodiment. The following will describe a detailed example of the sixth embodiment with reference to the accompanying drawings.

### (Schematic Configuration of Vehicle System)

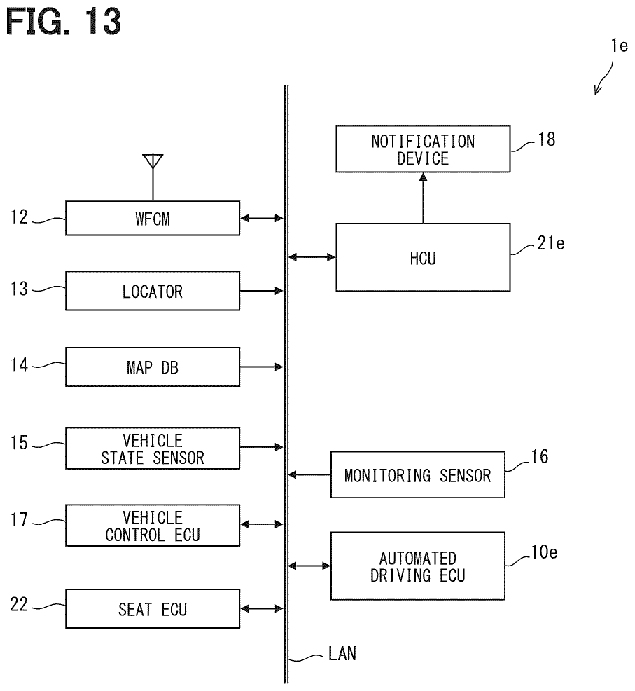

A vehicle system 1e shown in FIG. 13 can be used in an automated driving vehicle. As shown in FIG. 13, the vehicle system 1e includes an automated driving ECU 10e, the NFCM 11, the WFCM 12, the locator 13, the map DB 14, the vehicle state sensor 15, the periphery monitoring sensor 16, the vehicle control ECU 17, the notification device 18, the interior camera 19, the user input device 20, and a HCU 21e. The vehicle system 1e includes the automated driving ECU 10e instead of the automated driving ECU 10. The vehicle system 1e includes the HCU 21e instead of the HCU 21. Except for these points, the automated driving ECU 10e is similar to the vehicle system 1a of the second embodiment. The HCU 21e is similar to the HCU 21 of the first embodiment, except that it performs processing according to information output from the automated driving ECU 10e.

(Schematic Configuration of Automated Driving ECU)

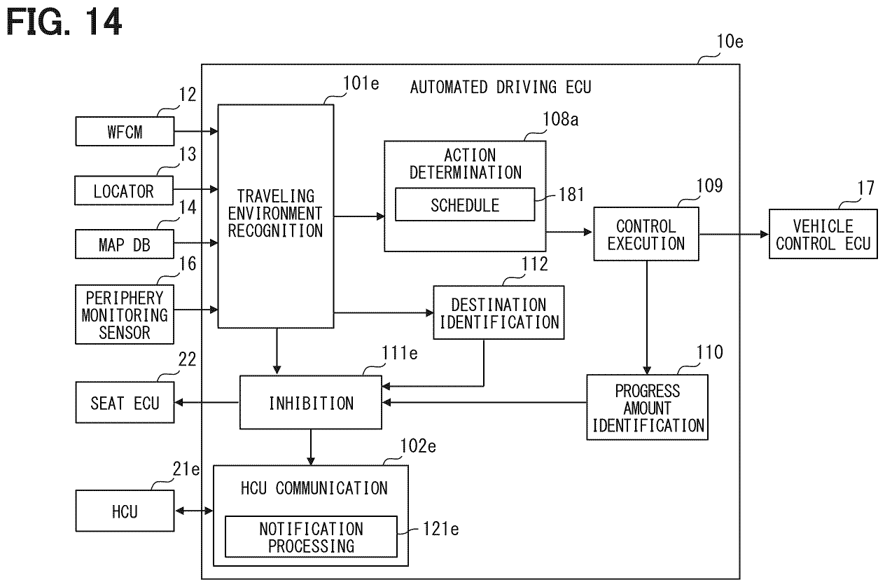

Next, a schematic configuration of the automated driving ECU 10e will be described with reference to FIG. 14. The automated driving ECU 10e is similar to the automated driving ECU 10a of the second embodiment, except for some differences in processing. The automated driving ECU 10e has a traveling environment recognition unit 101e, an HCU communication unit 102e, an action determination unit 108e, the control execution unit 109, the progress amount identification unit 110, an inhibition unit 111e, and the purpose identification unit 112 as functional blocks. The automated driving ECU 10e includes the traveling environment recognition unit 101e instead of the traveling environment recognition unit 101. The automated driving ECU 10e includes the HCU communication unit 102e instead of the HCU communication unit 102a. The automated driving ECU 10e includes the action determination unit 108e instead of the action determination unit 108a. The automated driving ECU 10e includes the inhibition unit 111e instead of the inhibition unit 111. The automated driving ECU 10c includes the purpose identification unit 112. Except for these points, the automated driving ECU 10e is similar to the automated driving ECU 10a of the second embodiment. The automated driving ECU 10e also corresponds to the vehicle control device. The execution of the processes of the functional blocks of the automated driving ECU 10e by the computer also corresponds to execution of a vehicle control method.

The purpose identification unit 112 is assumed to be the same as that described in the third embodiment. The traveling environment recognition unit 101e is similar to the traveling environment recognition unit 101 of the first embodiment, except for some differences in processing. This different point will be described below. It is preferable that the traveling environment recognition unit 101e also recognizes whether the vehicle is traveling on a specific road. The safety area here refers to an area for stopping. The specific road here is a road on which stable traveling is expected to continue for a certain distance or more. The specific road is, for example, an expressway, a motorway, and a road that do not have any right or left turning points for a certain distance. The certain distance may be a distance that is estimated to allow the occupant to continue the target motion comfortably, and may be arbitrarily set. The traveling environment recognition unit 101e may recognize, from the subject vehicle position measured by the locator 13 and the map data acquired from the map DB 14, whether the subject vehicle is traveling on the specific road. The traveling environment recognition unit 101e also corresponds to the traveling environment identification unit.

The inhibition unit 111e is similar to the inhibition unit 111 of the second embodiment, except for some differences in processing. This different point will be described below. The inhibition unit 111e changes the release timing for releasing the inhibition of the target motion depending on the traveling environment. In other words, after starting traveling in automated driving, even when the progress amount identified by the progress amount identification unit 110 has not yet reached a specified value, the inhibition unit 111e changes the release timing for releasing the inhibition of the target motion depending on the traveling environment. The traveling environment may be that recognized and identified by the traveling environment recognition unit 101e. As described above, the target motion is at least one of the reclining control or the second task. After starting in automated driving, even before the progress amount reaches the specified value and also inhibition of the target motion is released, depending on the traveling environment of the subject vehicle, there may be times when the effect of inhibiting the target motion is unlikely to be lost. In contrast, with the above configuration, by changing the timing for releasing the inhibition of the target motion depending on the traveling environment, it becomes possible to release the inhibition of the target motion at a timing when the effect of inhibiting the target motion is unlikely to be lost.

It is preferable that the inhibition unit 111e releases the inhibition of the target motion when the traveling environment becomes traveling on the above-described specific road. On the specific road, there are fewer external disturbances, and unexpected events become unlikely to occur during automated driving. In other words, difficulties are unlikely to arise even when the driver focuses their attention on something other than driving. Accordingly, with the above configuration, after starting traveling in automated driving, even before the progress amount reaches the specified value, it becomes possible to permit the target motion at a timing when difficulties due to the driver attention on something other than driving are unlikely to occur. As a result, there is no need to unnecessarily restrain the target motion, and it is possible to improve convenience for the occupant.

It is preferable that the inhibition unit 111e switches the inhibition of the target motion depending on whether the traveling start purpose identified by the purpose identification unit 112 is to go to work or go home. According to this, when it is preferable for the occupant to switch the inhibition of the target motion depending on whether the traveling start purpose is to go to work or to go home, it becomes possible to switch the inhibition of the target motion in a manner that is preferable for the occupant.

When the traveling start purpose identified by the purpose identification unit 112 is to go home, it is preferable that the inhibition unit 111e releases inhibition of the target motion from the traveling start time. On the other hand, when the traveling start purpose identified by the purpose identification unit 112 is to go to work, it is preferable that the inhibition unit 111e does not release the inhibition of the target motion from the traveling start time. As the time of going home, the occupant is likely to be more tired than at the time of going to work. In contrast, with the above configuration, when the occupant is more likely to be tired, the inhibition of the target motion from the traveling start time is released. It becomes easier for the occupant to refresh themselves.

The inhibition unit 111e may be configured to release inhibition of both the reclining control and the second task from the traveling start time when the traveling start purpose identified by the purpose identification unit 112 is to go home. On the other hand, when the traveling start purpose identified by the purpose identification unit 112 is to go to work, the inhibition unit 111e may set the target motions for which inhibition is to be released from the traveling start time to only the second task out of the reclining control and the second task. At the time of going to work, there is requirements for the occupant to check the route that the subject vehicle will travel, compared to the time of going home. In contrast, with the above configuration, the second task is permitted at both the time of going to work and time of going home. Thereby, it is possible to improve convenience for the occupant, while inhibiting reclining control when going to work. It is possible to satisfy the above-described requirements.

When the subject vehicle travels by automated driving on a route that has been traveled in the past, it is preferable for the inhibition unit 111e to release the inhibition of the target motion from the traveling start time. The inhibition unit 111e may determine the route along which the subject vehicle has traveled in the past under automated driving (hereinafter, referred to as the past travel route) from the subject vehicle's travel history. The past here can refer to the past on the same day. When re-traveling along the previously traveled route, there is little need for the occupant to check the route along which the subject vehicle will be traveling. According to the above configuration, when traveling along a route where there is little need for the occupant to check, it is possible to permit the target motion from the traveling start time. Thereby, it is possible to prioritize improved convenience for the occupant.

The HCU communication unit 102e includes a notification processing unit 121e as a sub-functional block. The HCU communication unit 102e is similar to the HCU communication unit 102 of the first embodiment, except for some differences in processing. This different point will be described below. It is preferable that the notification processing unit 121e performs the following notification when an operation by the driver attempting to execute a target motion is detected while the target motion is being inhibited by the inhibition unit 111e. It is preferable that the notification processing unit 121e issue an alert notification, which is at least one of a target motion inhibition in-progress notification or an inhibition release point notification. The target motion inhibition in-progress notification is a notification indicating that the target motion is being inhibited. The inhibition release point notification is a notification that indicates the point where inhibition of the target motion is released. The point at which inhibition of the target motion is released may be, for example, a point at which the subject vehicle enters a specific road on the scheduled route.

The driver's operation to execute the target motion may be detected, for example, by the HCU 21e in the following manner. In the case of reclining control, it may be detected based on whether an operation input for instruction of adjustment of the seat position is received by an operation device. The second task may also be detected based on whether an operation input required for executing the second task has been received by an operation device of the subject vehicle. Regarding the second task, an operation of the driver attempting to execute the second task may be detected by performing image recognition on an image of the driver captured by a camera similar to the interior camera 19. The notification processing unit 121e may perform the above-mentioned alert notification using the detection result of the driver's operation to execute the target motion in the HCU 21e. According to the above configuration, it becomes easy to cause an occupant who is about to perform the target motion to recognize that the target motion is not permitted. The notification processing unit 121e also corresponds to the notification control unit.

### (Inhibition Limitation-Related Process by Automated Driving ECU)

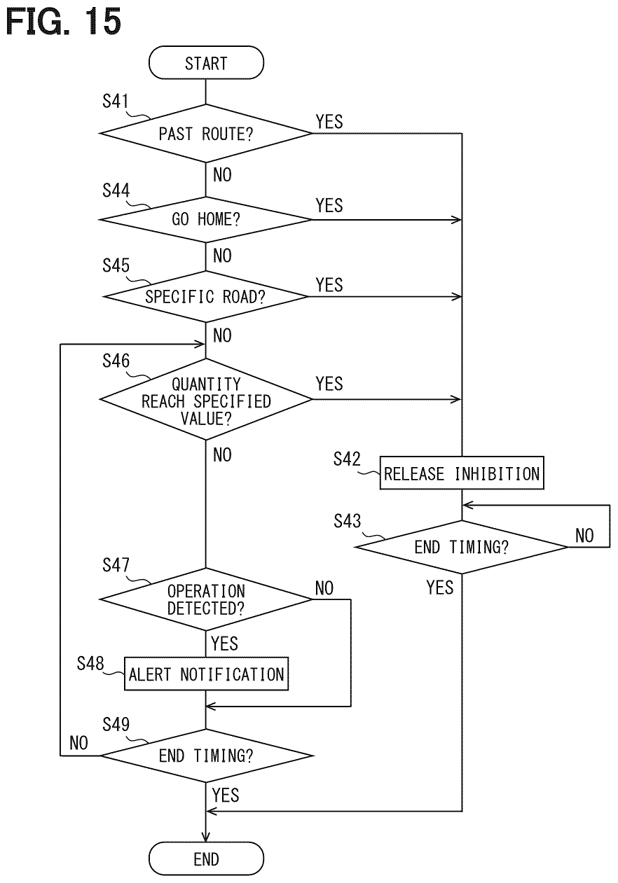

Here, an example of a flow of processes (hereinafter, inhibition release-related process) related to the release of inhibition of the target motion in the automated driving ECU 10e will be described with reference to a flowchart of FIG. 15. The flowchart in FIG. 15 may be configured to start, for example, when the subject vehicle starts traveling by automated driving.

First, in S41, when the inhibition unit 111e determines that the scheduled route of the subject vehicle is the previous traveling route (YES in S41), the process proceeds to S42. On the other hand, when the inhibition unit 111e determines that the scheduled route of the subject vehicle is not the past traveling route (NO in S41), the process proceeds to S44.

In S42, the inhibition unit 111e releases the inhibition of the target motions of both the reclining control and the second task, and the process proceeds to S43. In S43, when it is time to end the inhibition release-related process (YES in S43), the inhibition release-related process ends. The inhibition release-related process may end when the power switch of the subject vehicle is turned off. On the other hand, when it is not time to end the inhibition release-related process (NO in S43), the process of S43 is repeated.

In S44, when the traveling start purpose identified by the purpose identification unit 112 is to go home (YES in S44), the process proceeds to S42. On the other hand, when the traveling start purpose identified by the purpose identification unit 112 is not to go home (NO in S44), the process proceeds to S45. A case where the traveling start purpose identified by the purpose identification unit 112 is not to go home is, for example, a case where the traveling start purpose is to go to work.

In S45, when the inhibition unit 111e determines that the traveling environment of the subject vehicle has become one in which the subject vehicle is traveling on the specific road (YES in S45), the process proceeds to S42. On the other hand, when the inhibition unit 111e has not determined that the traveling environment of the subject vehicle has become the specific road (NO in S45), the process proceeds to S46.

In S46, when the inhibition unit 111e determines that the progress amount has reached the specified value by the progress amount identification unit 110 (YES in S46), the process proceeds to S42. On the other hand, when the inhibition unit 111e has not determined that the progress amount has reached the specified value by the progress amount identification unit 110 (NO in S46), the process proceeds to S47.

In S47, when the HCU 21e detects an operation by the driver to execute the target motion (YES in S47), the process proceeds to S48. On the other hand, when the HCU 21e has not detected an operation by the driver to execute the target motion (NO in S47), the process proceeds to S49.

In S48, the notification processing unit 121e issues the alert notification, and the process proceeds to S49. In S49, when it is time to end the inhibition release-related process (YES in S49), the inhibition release-related process ends. On the other hand, when it is not time to end the inhibition release-related process (NO in S49), the process returns to S46 and is repeated.

(Seventh Embodiment)

In the above-described embodiment, the automated driving ECUs 10, 10a, 10b, 10c, 10d, and 10e are configured to correspond to the vehicle control device, but this is not necessarily limited to this. For example, an ECU other than the automated driving ECUs 10, 10a, 10b, 10c, 10d, and 10e may correspond to the vehicle control device. In addition, in the above-described embodiment, the automated driving ECUs 10, 10a, 10b, 10c, 10d, and 10e are provided with the traveling environment recognition units 101, 101b, and 101e, respectively, but this is not necessarily limited to the above. For example, an ECU other than the automated driving ECUs 10, 10a, 10b, 10c, 10d, and 10e may be configured to perform the functions of the traveling environment recognition units 101, 101b, and 101e. In this case, the automated driving ECUs 10, 10a, 10b, 10c, 10d, and 10e acquire information recognized by the ECUs that perform the functions of the traveling environment recognition units 101, 101b, and 101e, and identify the traveling environment. In this case, the ECU that performs the functions of the traveling environment recognition units 101b and 101e corresponds to the traveling environment identification unit.

It should be noted that the present disclosure is not limited to the embodiments described above, and various modifications are possible within the scope indicated in the present disclosure, and embodiments obtained by appropriately combining technical means disclosed in different embodiments are also included in the technical scope of the present disclosure. Further, the control unit and the method thereof described in the present disclosure may be implemented by a dedicated computer which includes a processor programmed to perform one or more functions executed by a computer program. Alternatively, the device and the method thereof described in the present disclosure may also be implemented by a dedicated hardware logic circuit. Alternatively, the device and the method thereof described in the present disclosure may also be implemented by one or more dedicated computers configured as a combination of a processor executing a computer program and one or more hardware logic circuits. The computer program may also be stored in a computer-readable non-transitory tangible storage medium as instructions to be executed by a computer.

What is claimed is:

1. A vehicle control device configured to start automated driving that assists steering, acceleration, and deceleration from a traveling start time and be used in a vehicle configured to switch from manual driving to the automated driving, the vehicle control device comprising at least one of (i) a circuit and (ii) a processor with a memory storing computer program code executable by the processor, the at least one of the circuit and the processor configured to cause the vehicle control device to:
identify an operation in the vehicle received from a driver of the vehicle;
permit a traveling start by the automated driving without a condition that a specific operation has been identified at a time of switching from the manual driving to the automated driving, the specific operation being a plurality of predetermined operations; and
permit the traveling start by the automated driving based on the specific operation identified at the traveling start time of the vehicle.

2. The vehicle control device according to claim 1, wherein
the at least one of the circuit and the processor is further configured to cause the vehicle control device to:
be used in the vehicle configured to switch from the manual driving to the automated driving; and
set an automated driving mode that enables the traveling start by the automated driving in response to a trigger that an activation operation to activate a driving source for traveling of the vehicle has been performed; and
switch from the automated driving mode to a manual driving mode in which the vehicle travels by the manual driving when an operation that is other than the specific operation and is for requesting the manual driving has been identified.

3. The vehicle control device according to claim 1, wherein
the at least one of the circuit and the processor is further configured to cause the vehicle control device to:
set an automated driving mode that enables the traveling start by the automated driving in response to a trigger that an activation operation to activate a driving source for traveling of the vehicle has been performed; and
set, in advance, an automation level of driving to be performed in the automated driving mode.

4. The vehicle control device according to claim 1, wherein
the at least one of the circuit and the processor is further configured to cause the vehicle control device to set, in advance, an automation level of driving that enables the traveling start in response to a trigger that an operation input to activate a driving source for traveling of the vehicle has been performed.

5. The vehicle control device according to claim 3, wherein
the at least one of the circuit and the processor is further configured to cause the vehicle control device to:
acquire subject vehicle-related information that is information about at least one of the vehicle, a traveling environment of the vehicle, or a driver of the vehicle;
cause a notification device placed in a vehicle compartment of the vehicle to provide a notification;
cause the notification device to propose an automation level recommended to the driver as the automation level of the driving to be performed from the traveling start time, based on the acquired subject vehicle-related information.

6. The vehicle control device according to claim 1, wherein:
the at least one of the circuit and the processor is further configured to cause the vehicle control device to:
set an automated driving mode that enables the traveling start by the automated driving in response to a trigger that an activation operation to activate a driving source for traveling of the vehicle has been performed; and
predict an occurrence of a situation in which the vehicle is not possible to perform the automated driving, and
in a case of predicting the occurrence of the situation in which the vehicle is not possible to perform the automated driving within a predetermined distance or a predetermined time after the vehicle starts traveling, even when an activation operation is performed to activate a driving source for traveling of the vehicle, the at least one of the circuit and the processor is further configured to cause the vehicle control device not to set the vehicle to the automated driving mode, and cause the vehicle control device to set the vehicle to a manual driving mode in which the vehicle travels by manual driving.

7. The vehicle control device according to claim 1, wherein
the at least one of the circuit and the processor is further configured to cause the vehicle control device to:
set, in advance, an automation level of the automated driving that enables the traveling start in response to a trigger that an activation operation to activate a driving source for traveling of the vehicle has been performed; and
when an automation level of the automated driving permitted based on identification is equal to or higher than a sleep permission automation level, set a less operation number of the specific operation than an operation number when the automation level of the automated driving is less than the sleep permission level,
the identification is identification of the specific operation at the traveling start time of the vehicle, and
the sleep permission level is an automation level at which the driver is permitted to sleep.

8. The vehicle control device according to claim 1, wherein
the vehicle control device is configured to be also used in a vehicle configured to perform an activation operation to activate a driving source for traveling of the vehicle via at least one of a remote operation or an operation of an input device of the vehicle, and
when the activation operation is performed via the remote operation, the at least one of the circuit and the processor is further configured to cause the vehicle control device to set a larger operation number of the specific operation than an operation number when the activation operation is performed via the operation of the input device.

9. The vehicle control device according to claim 1, wherein
the at least one of the circuit and the processor is further configured to cause the vehicle control device to set a larger operation number of the specific operation when the vehicle starts traveling backward than an operation number when the vehicle starts traveling forward.

10. The vehicle control device according to claim 1, wherein
the vehicle control device is configured to be also used in a vehicle configured to perform an activation operation to activate a driving source for traveling of the vehicle via at least one of a remote operation or an operation of an input device of the vehicle, and
the at least one of the circuit and the processor is further configured to cause the vehicle control device to:
switch between a periphery monitoring necessary state and a periphery monitoring unnecessary state for the driver;
when the activation operation is performed via the operation of the input device, switch to the periphery monitoring unnecessary state; and
when the activation operation is performed via the remote operation, switch to the periphery monitoring necessary state.

11. The vehicle control device according to claim 1, wherein
the at least one of the circuit and the processor is further configured to cause the vehicle control device to:
perform switching between a periphery monitoring necessary state and a periphery monitoring unnecessary state for the driver in the vehicle,
when the vehicle starts traveling forward, perform the switching to the periphery monitoring unnecessary state; and
when the vehicle starts traveling backward, perform the switching to the periphery monitoring necessary state.

12. The vehicle control device according to claim 1, wherein
the at least one of the circuit and the processor is further configured to cause the vehicle control device to change a stoppable position of the vehicle depending on whether of a manual traveling start state or an automatic traveling start state,
the stoppable position is a position at which the vehicle is permitted to stop,
the manual traveling start state is a state where the automated driving is performed after switching from the manual driving to the automated driving, and
the automatic traveling start state is a state where the automated driving is performed from the traveling start time.

13. The vehicle control device according to claim 12, wherein
the at least one of the circuit and the processor is further configured to cause the vehicle control device to change the stoppable position so that stopping is limited to a safety area, and
the safety area is an area where the switching from the automated driving to the manual driving is less likely to occur in the automatic traveling start state than in the manual traveling start state.

14. The vehicle control device according to claim 13, wherein
the at least one of the circuit and the processor is further configured to cause the vehicle control device to change the stoppable position so that stopping is limited to the safety area by performing a setting that a destination of the automated driving is only limited to the safety area.

15. The vehicle control device according to claim 13, wherein
the at least one of the circuit and the processor is further configured to cause the vehicle control device to:
identify a traveling environment of the vehicle; and
lower an automation level of the automated driving performed by the vehicle, when the vehicle is in the automatic traveling start state and also the at least one of the circuit and the processor has determined that the vehicle is not possible to stop in the safety area based on the identified traveling environment.

16. The vehicle control device according to claim 12, wherein
the at least one of the circuit and the processor is further configured to cause the vehicle control device to:
identify a traveling start purpose of the vehicle; and
when, in the automatic traveling start state, the identified traveling start purpose is to go to work or to go home, set an operation amount of the specific operation to be fewer than an operation amount when the identified traveling start purpose is not to go to work or to go home, and
the operation amount is a traveling start condition.

17. The vehicle control device according to claim 1, wherein
the at least one of the circuit and the processor is further configured to cause the vehicle control device to:
determine whether the automated driving is possible to be performed by starting the automated driving from the traveling start time;
cause a notification device placed in a vehicle compartment of the vehicle to provide a notification; and
in a case where the driver gets into the vehicle,
when determining that the automated driving is possible to start from the traveling start time and be performed, cause the notification device to provide an automatic traveling start proposal notification that is a notification proposing to perform the automated driving from the traveling start time, and
when determining that the automated driving is not possible to start from the traveling start time of the vehicle, cause the notification device not to provide the automatic traveling start proposal notification.

18. The vehicle control device according to claim 17, wherein
in the case where the driver gets into the vehicle, when determining that the automated driving is not possible to start from the traveling start time and be performed, the at least one of the circuit and the processor is further configured to cause the vehicle control device to cause the notification device to provide a notification that the automated driving is not possible to start from the traveling start time and be performed.

19. The vehicle control device according to claim 17, wherein
in response to the automatic traveling start proposal notification, in a case where the vehicle stops due to an operation of an occupant of the vehicle within a specified time after the specific operation is identified, when the vehicle restarts, the at least one of the circuit and the processor is further configured to cause the vehicle control device to limit the traveling start of automated driving from the traveling start time.

20. The vehicle control device according to claim 1, wherein
the at least one of the circuit and the processor is further configured to cause the vehicle control device to:
determine a progress amount from a traveling start by the automated driving of the vehicle; and
limit acceleration of the vehicle in a state until determining that the progress amount has reached a specified value after the traveling start by automated driving of the vehicle, compared to a state after determining that the progress amount has reached the specified value.

21. A vehicle control device configured to start automated driving that assists steering, acceleration, and deceleration from a traveling start time and be used in a vehicle configured to perform reclining control of an electric seat, the vehicle control device comprising at least one of (i) a circuit and (ii) a processor with a memory storing computer program code executable by the processor, the at least one of the circuit and the processor configured to cause the vehicle control device to:
determine a progress amount from a traveling start by the automated driving of the vehicle; and
inhibit a target motion until determining that the progress amount has reached a specified value after the traveling start by the automated driving of the vehicle,
wherein
the target motion is at least one of the reclining control or a second task that is a motion other than driving that is permitted to a driver of the vehicle.

22. The vehicle control device according to claim 21, wherein
the at least one of the circuit and the processor is further configured to cause the vehicle control device to:
identify a traveling environment of the vehicle,
change a release timing for releasing inhibition of the target motion depending on the identified traveling environment.

23. The vehicle control device according to claim 22, wherein
the at least one of the circuit and the processor is further configured to cause the vehicle control device to release the inhibition of the target motion when the identified traveling environment becomes traveling on a road where stable traveling is estimated to continue for a certain distance or more.

24. The vehicle control device according to claim 21, wherein
the at least one of the circuit and the processor is further configured to cause the vehicle control device to:
cause a notification device placed in a vehicle compartment of the vehicle to provide a notification;
when an operation by the driver attempting to perform the target motion is detected while the target motion is being inhibited; and
cause the notification device to provide at least one of a notification indicating that the target motion is being inhibited or a notification indicating a point at which inhibition of the target motion is released.

25. The vehicle control device according to claim 21, wherein
the at least one of the circuit and the processor is further configured to cause the vehicle control device to:
identify a traveling start purpose of the vehicle; and
switch inhibition of the target motion depending on whether the identified traveling start purpose is to go to work or go home.

26. The vehicle control device according to claim 25, wherein
when the identified traveling start purpose is to go home, the at least one of the circuit and the processor causes the vehicle control device to release the inhibition of the target motion from the traveling start time, and
when the identified traveling start purpose is to go to work, the at least one of the circuit and the processor causes the vehicle control device not to release the inhibition of the target motion from the traveling start time.

27. The vehicle control device according to claim 21, wherein
when the vehicle travels in an automated driving mode on a route along which the vehicle traveled in past, the at least one of the circuit and the processor causes the vehicle control device to release inhibition of the target motion from the traveling start time.

28. A vehicle control method that is used for a vehicle configured to start automated driving that assists steering, acceleration, and deceleration from a traveling start time and switch from manual driving to the automated driving and performed by at least one processor, the vehicle control method comprising:
identifying an operation in the vehicle received from a driver of the vehicle;
permitting a traveling start by the automated driving without a condition that a specific operation has been identified at a time of switching from the manual driving to the automated driving, the specific operation being a plurality of predetermined operations; and
permitting the traveling start by the automated driving based on the identified specific operation at the traveling start time of the vehicle.

29. A vehicle control method that is used for a vehicle configured to start automated driving that assists steering, acceleration, and deceleration from a traveling start time and perform reclining control of an electric seat and performed by at least one processor, the vehicle control method comprising:
determining a progress amount from a traveling start by the automated driving of the vehicle; and
inhibiting a target motion until the vehicle control method determines that the progress amount has reached a specified value after the traveling start by the automated driving of the vehicle,
wherein
the target motion is at least one of the reclining control or a second task that is a motion other than driving that is permitted to a driver of the vehicle.
